(19) United States
(12) Patent Application Publication
(10) Pub. No.: US 2026/0348236 A1
(43) Pub. Date: Nov. 5, 2026

(54) LOCKABLE HINGE FOR LADDER

(71) Applicant: Werner Co., Itasca, IL (US)

(72) Inventors: Tek LENTINE, Cary, IL (US); Derek BIBLER, Elk Grove Village, IL (US)

(21) Appl. No.: 19/124,692

(22) PCT Filed: Oct. 31, 2023
(86) PCT No.: PCT/US2023/036498

§ 371 Date: Apr. 25, 2025

Related U.S. Application Data
(60) Provisional application No. 63/421,505, filed on Nov. 1, 2022.

(51) Int. Cl. E06C 7/50; E06C 1/18; E06C 1/32; F16C 11/10

(52) U.S. Cl. CPC E06C 7/50; E06C 1/18; E06C 1/32; F16C 11/10

(57) ABSTRACT

Apparatuses, systems, and methods pertaining to ladder and a lockable hinge assembly of a ladder are provided herein. The lockable hinge assembly is adjustable from a locked state to an unlocked state to permit rotation of a rear ladder section relative to a front ladder section to change the angle therebetween and lockable to rotationally fix the rear ladder section at a desired angle and position relative to the front ladder section. In some approaches, the lockable hinge assembly includes a sliding lock assembly that permits both hinges of the lockable hinge assembly to be locked or unlocked manually using one hand. Lockable hinge assemblies having mechanisms for removing or reducing slack in the hinges are also provided.

### RELATED APPLICATIONS

This application claims the benefit of U.S. Provisional Application No. 63/421,505, filed Nov. 1, 2022, the entire contents of which are incorporated herein by reference.

### TECHNICAL FIELD

This disclosure relates to ladder hinges, and, in particular, to hinges for multi-purpose ladders or other ladders with sections that can be pivoted and locked into different positions relative to one another.

### BACKGROUND

Ladder hinges are used to allow movement of a rear section of a ladder relative to a front section of a ladder to change the position of the ladder. For instance, in certain ladders, the hinge may permit the rear section to be pivoted relative to the front section to provide, for example, a stepladder position, an extended straight position, or a folded or lean-safe position of the ladder.

Ladder hinges typically include a locking mechanism so that the ladder can be securely locked into position after being pivoted to the desired position. Commonly, the locking mechanism includes a handle or button positioned on an outer side of each hinge. The buttons engage a spring-biased axial shaft that extends through the hinge plates and that moves locking pins on an inner side of each hinge to engage or disengage locking holes in the hinge. When the buttons are pressed, the locking pins disengage the locking holes in the hinge, permitting rotation of the ladder sections relative to one another. When the buttons are released, the locking pins engage the locking holes in the hinge, inhibiting rotation of the ladder sections relative to one another.

In use, such locking mechanisms require a user to use one hand to operate the locking mechanism on one hinge and another hand to operate the locking mechanism on the other hinge. Thus, the locking mechanisms must be coordinated using two hands at the same time to unlock, pivot, and lock the ladder.

In addition, many lockable ladder hinges are formed by rotatably attaching plates which are coupled to ladder rails on the front section and the rear section of the ladder. Because these plates are separate components which are attached together, and the locking holes in the plates are commonly produced with different tolerances, there may be space between the plates or within the locking holes that causes the plates to wiggle or vibrate between each other during use or transportation of the ladder. This movement between the plates in the hinge is known as slack or slop, which may weaken or damage the hinge over time.

### BRIEF DESCRIPTION OF THE DRAWINGS

FIG. 1 is a rear-side perspective view of a ladder according to a first embodiment, shown in a stepladder position of the ladder.

FIG. 2 is an enlarged view of a portion of the ladder of FIG. 1 showing a lockable hinge assembly thereof.

FIG. 3 is an enlarged partial view of the ladder of FIG. 1 showing the lockable hinge assembly with the main housing for the lockable hinge assembly removed.

FIG. 4 is an exploded view of the lockable hinge assembly of the ladder of FIG. 1.

FIG. 5 is an outer-side perspective view of a hinge of the lockable hinge assembly FIG. 2.

FIG. 6 is an inner-side perspective view of the hinge of FIG. 5.

FIG. 7 is an additional inner-side perspective view of the hinge of FIG. 5.

FIG. 8 is a first-side perspective view of a cover plate of the hinge of FIG. 5.

FIG. 9 is a second-side perspective view of the cover plate of FIG. 8.

FIG. 10 is a cross-sectional view of a portion of the ladder of FIG. 1 taken along line 10-10 of FIG. 3.

FIG. 11 is a first-side perspective view of a stationary plate of the hinge of FIG. 5.

FIG. 12 is a second-side perspective view of the stationary plate of FIG. 11.

FIG. 13 is an outer-side perspective view of the hinge of FIG. 5 showing only the cover plate and the stationary plate with the rotational components removed.

FIG. 14. is an enlarged partial perspective view of the outer side of the hinge of FIG. 5.

FIG. 15 is a first-side perspective view of a rotational plate of the hinge of FIG. 5.

FIG. 16 is a second-side perspective view of the rotational plate of FIG. 15.

FIG. 17 is a first-side perspective view of a rotational support arm of the hinge of FIG. 5.

FIG. 18 is a second-side perspective view of the rotational support arm of FIG. 17.

FIG. 19 is an outer-side perspective view of the hinge of FIG. 5 showing only the rotational plate and the rotational support arm with the cover plate and the stationary plate removed.

FIG. 20 is an inner side perspective view of the hinge of FIG. 5 showing only the rotational plate and the rotational support arm with the cover plate and the stationary plate removed.

FIG. 21 is an enlarged partial perspective view of the inner side of the hinge of FIG. 5 showing only the rotational plate and the rotational support arm with the cover plate and the stationary plate removed.

FIG. 22 is an enlarged partial perspective view of the outer side of the hinge of FIG. 5 showing only the rotational plate and the rotational support arm with the cover plate and the stationary plate removed.

FIG. 23 is a first-side perspective view of a bushing for a locking bole of the hinge of FIG. 5.

FIG. 24 is a second-side perspective view of the bushing of FIG. 23.

FIG. 25 is a cross-sectional view of the hinge of FIG. 5 taken along line 25-25 of FIG. 14.

FIG. 26 is an enlarged partial view of the cross-sectional view of FIG. 25.

FIG. 27 is an enlarged partial view of the hinge of FIG. 5 showing the locking hole of the rotational plate and the bushing therein.

FIG. 28 is an exploded bottom perspective view of a sliding lock assembly of the lockable hinge assembly of FIG. 2.

FIG. 29 is an exploded top perspective view of the sliding lock assembly of FIG. 28 without the main housing.

FIG. 30 is an enlarged partial view of the sliding lock assembly of the lockable hinge assembly of FIG. 2.

FIG. 31 is an additional enlarged partial view of the sliding lock assembly of the lockable hinge assembly of FIG. 2.

FIG. 32 is an enlarged partial rear-side perspective view of the ladder of FIG. 1 shown in an extended position of the ladder.

FIG. 33 is an enlarged partial rear-side perspective view of the ladder of FIG. 1 shown in a folded or lean-safe position of the ladder.

FIG. 34 is an inner-side perspective view of a hinge assembly according to a second embodiment.

FIG. 35 is a first-side perspective view of a locking bolt of the hinge assembly of FIG. 34.

FIG. 36 is a first-side elevation view of the locking bolt of FIG. 35.

FIG. 37 is a first-side perspective view of a first fixed plate of the hinge assembly of FIG. 34.

FIG. 38 is a first-side elevation view of a rotational plate of the hinge assembly of FIG. 34.

FIG. 39 is a first-side elevation view of a second fixed plate of the hinge assembly of FIG. 34.

FIG. 40 is a partial outer-side elevation view of the hinge assembly of FIG. 34 in an unlocked position of the hinge assembly.

FIG. 41 is a partial outer-side elevation view of the hinge assembly of FIG. 34 in a locked position of the hinge assembly.

FIG. 42 is a partial inner-side perspective view of the hinge assembly of FIG. 34 in an unlocked position of the hinge assembly.

FIG. 43 is an outer-side perspective view of a hinge assembly according to a third embodiment.

FIG. 44 is an outer-side perspective view of the hinge assembly of FIG. 43 with a first rotational component thereof removed.

FIG. 45 is an outer-side view of the hinge assembly of FIG. 43 with the first rotational component removed, showing the hinge assembly in a first locked position thereof.

FIG. 46 is an outer-side view of the hinge assembly of FIG. 43 with the first rotational component removed, showing the hinge assembly in a second locked position thereof.

FIG. 47 is a first-side view of a fixed plate of the hinge assembly of FIG. 43.

FIG. 48 is first-side view of a second rotational component of the hinge assembly of FIG. 43.

FIG. 49 is an outer-side view of the hinge assembly of FIG. 43 shown with an additional fixed housing.

FIG. 50 is an outer-side view of a hinge assembly according to a fourth embodiment.

FIG. 51 is an inner-side view of the hinge assembly of FIG. 50.

FIG. 52 is a cross-sectional view of the hinge assembly of FIG. 50 taken along line 52 -52 of FIG. 51.

FIG. 53 is a cross-sectional view of the hinge assembly of FIG. 50 taken along line 53 -53 of FIG. 51.

FIG. 54 is the cross-sectional view of FIG. 53 with a stationary plate removed.

FIG. 55 is a cross-sectional view of the hinge assembly of FIG. 50 taken along line 55-55 of FIG. 50 with the stationary plate removed.

FIG. 56 is a top perspective view of the stationary plate of the hinge assembly of FIG. 50.

FIG. 57 is a side perspective view of the stationary plate of FIG. 56.

FIG. 58 the cross-sectional view of FIG. 55 shown with the stationary plate present.

FIG. 59 is a simplified cross-sectional view of a hinge assembly of a fifth embodiment.

FIG. 60 is a simplified cross-sectional view of a hinge assembly of a sixth embodiment.

FIG. 61 is a simplified cross-sectional view of a hinge assembly of seventh embodiment.

FIG. 62 is a simplified cross-sectional view of a hinge assembly of an eighth embodiment.

FIG. 63 is a simplified cross-sectional view of a bolt according to a ninth embodiment.

FIG. 64 is a simplified cross-sectional view of a hinge assembly that includes the bolt of FIG. 63, showing the hinge assembly in a locked position.

FIG. 65 is a simplified cross-sectional view of a hinge assembly according to a tenth embodiment.

FIG. 66 is an outer-side perspective view of a hinge assembly according to an eleventh embodiment, shown in an unlocked condition thereof.

FIG. 67 is an inner-side perspective view of the hinge assembly of FIG. 66.

FIG. 68 is a first-side perspective view of a fixed plate of the hinge assembly of FIG. 66.

FIG. 69 is a perspective view of a bolt of the hinge assembly of FIG. 66.

FIG. 70 is an outer-side perspective view of the hinge assembly of FIG. 66, shown in a first locked condition.

FIG. 71 is an outer-side perspective view of the hinge assembly of FIG. 66, shown in a second locked condition.

FIG. 72 is an inner-side perspective view of a hinge assembly according to a twelfth embodiment.

FIG. 73 is an enlarged partial perspective view of the hinge assembly of FIG. 72.

FIG. 74 is an outer-side perspective view of a hinge assembly according to a thirteenth embodiment.

FIG. 75 is an inner-side perspective view of the hinge assembly of FIG. 74.

FIG. 76 is a perspective view of a hinge-facing side of a second rotational component of the hinge assembly of FIG. 74.

FIG. 77 is a perspective view of a hinge-facing side of a cover plate of the hinge assembly of FIG. 74.

FIG. 78 is a perspective view of the outer-side of the hinge assembly of FIG. 74 showing only the cover plate, a cam ring, and the springs and rollers disposed in the cover plate.

FIG. 79 is a perspective view of an external side of the cover plate of FIG. 77.

FIG. 80 is a perspective view of a hinge-facing side of the cover plate of the hinge assembly of FIG. 74 with the springs and rollers removed.

FIG. 81 is a perspective view of a side of an inner stationary plate of the hinge assembly of FIG. 74.

FIG. 82 is a rear perspective view of a ladder according to a fourteenth embodiment.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present disclosure. Also, common but well-understood elements that are useful or necessary in a commercially feasible embodiment may be omitted in order to facilitate a less obstructed view of these various embodiments of the present invention. Certain actions and/or steps may be described or depicted in a particular order of occurrence when such specificity with respect to sequence is not actually required. The terms and expressions used herein have the ordinary technical meaning as is accorded to such terms and expressions by persons skilled in the technical field as set forth above except where different specific meanings have otherwise been set forth herein.

Further, the following description of illustrative embodiments according to principles of the present disclosure is intended to be read in connection with the accompanying drawings, which are to be considered part of the entire written description. In the description of embodiments disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the disclosure are illustrated by reference to certain embodiments. Accordingly, the invention expressly should not be limited to such embodiments illustrating some possible non-limiting combination of features that may exist alone or in other combinations of features.

### DETAILED DESCRIPTION

Generally speaking, pursuant to these teachings, reconfigurable ladders with sections or portions that are movable relative to one another (e.g., multi-position ladders) may include a locking mechanism that permits the movable sections to be secured relative to one another. In some configurations, the locking mechanism is a lockable pivot arrangement or lockable hinge assembly that includes a stationary plate, a rotational plate, a cover plate, and a sliding lock.

In one illustrative approach, the lockable pivot arrangement includes a first hinge with a first stationary plate fixed to a first rail of the first ladder section and having a first pin hole for receiving a first locking pin, a first rotational plate fixed to the first rail of the second ladder section and rotatably coupled to the first stationary plate, the first rotational plate including a first plurality of locking holes for receiving the first locking pin to lock the second ladder section in a plurality of positions relative to the first ladder section. The arrangement also may include a first cover plate coupled to and fixed from rotation relative to the first stationary plate, the first cover plate including a first opening for receiving the first locking pin that is aligned with the first pin hole of the first stationary plate. A second hinge, similar to the first hinge is also contemplated.

In some aspects, the lockable pivot arrangement includes a sliding lock mechanism positioned between the first hinge and the second hinge. By some approaches, the sliding lock mechanism includes a first locking pin and a second locking pin for engaging and disengaging the first plurality of locking holes and a second plurality of locking holes of the first and second rotational plates, respectively. In addition, the sliding lock mechanism also may include a first sliding assembly including a first actuator coupled to the first locking pin and a second sliding assembly including a second actuator coupled to the second locking pin along with first and second elastomeric bias elements acting to bias the first sliding assembly and the second sliding assembly away from each other.

In use, an unlocked state of the first and second hinges is provided when the first and second actuators are moved towards each other and against the bias so that the first and second locking pins exit one of the first plurality of locking holes and one of the second plurality of locking holes of the first and second rotational plates to allow rotation of the second ladder section relative to the first ladder section.

In some aspects, a lockable hinge for a ladder is provided, the ladder having a first ladder section and a second ladder section, each ladder section having first and second rails in parallel to one another and at least one rung connecting the first and second rails, the hinge connecting the first and second ladder sections and enabling selective rotation of the second ladder section relative to the first ladder section. In embodiments, the lockable hinge includes a stationary plate fixable to the first rail of the first ladder section and having a pin hole for receiving a locking pin and a rotational plate fixable to the first rail of the second ladder section and rotatably coupled to the stationary plate, the rotational plate including a plurality of locking holes for receiving the locking pin to lock the second ladder section in a plurality of positions relative to the first ladder section. In certain embodiments, a cover plate may be coupled to and fixed from rotation relative to the stationary plate, the cover plate including an opening for receiving the locking pin that is aligned with the pin hole of the stationary plate.

In an illustrative configuration, the stationary plate is sandwiched between the rotational plate and the cover plate, the rotational plate comprising an outermost portion of the hinge. In some approaches, plurality of locking holes extend entirely through the rotational plate so that the locking pin inserted in one of the plurality of locking holes is externally visible.

In some embodiments, any of the ladders and lockable hinge assemblies herein may be modified to include one or more additional mechanisms to reduce or eliminate slack in the first and second hinges. In embodiments, the hinge includes a stationary plate attached to the first front rail and a rotational plate attached to the first rear rail, rotatably coupled to the stationary plate. The first rear rail is able to be rotated to a desired position relative to the first front rail by the rotational plate rotating relative to the stationary plate. The hinge includes a hinge lock which locks the rotational plate relative to the stationary plate so that the ladder is locked in the desired position. The hinge includes a first slack removing mechanism in contact with the rotational plate and the stationary plate to remove or reduce slack between the rotational plate and the stationary plate when the rotational plate is locked in the desired position. The same configuration can be applied to a second hinge that rotates a second rear rail relative to a second front rail.

Specifically, the slack removing mechanisms eliminate slack in a ladder hinge by applying a continuous force between the rotational or moving plate of the and the stationary or fixed plate when the hinge is locked. By certain approaches, the slack removing mechanisms include a spring and/or a wedge to create the tension between the rotational plate and the stationary plate.

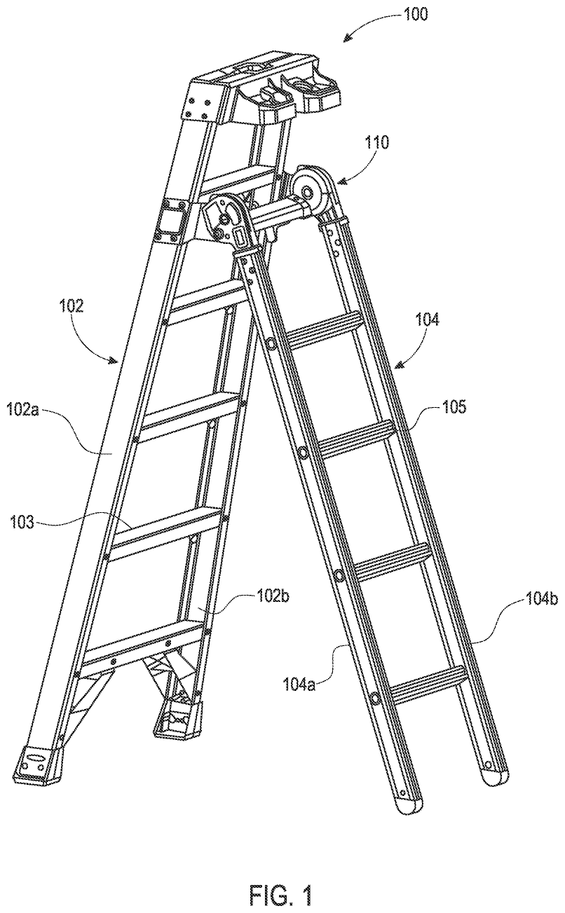

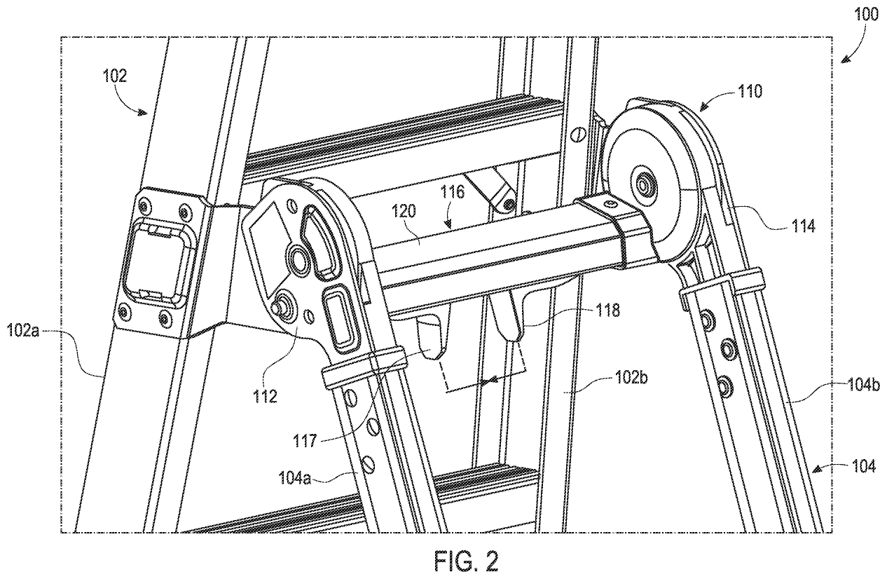

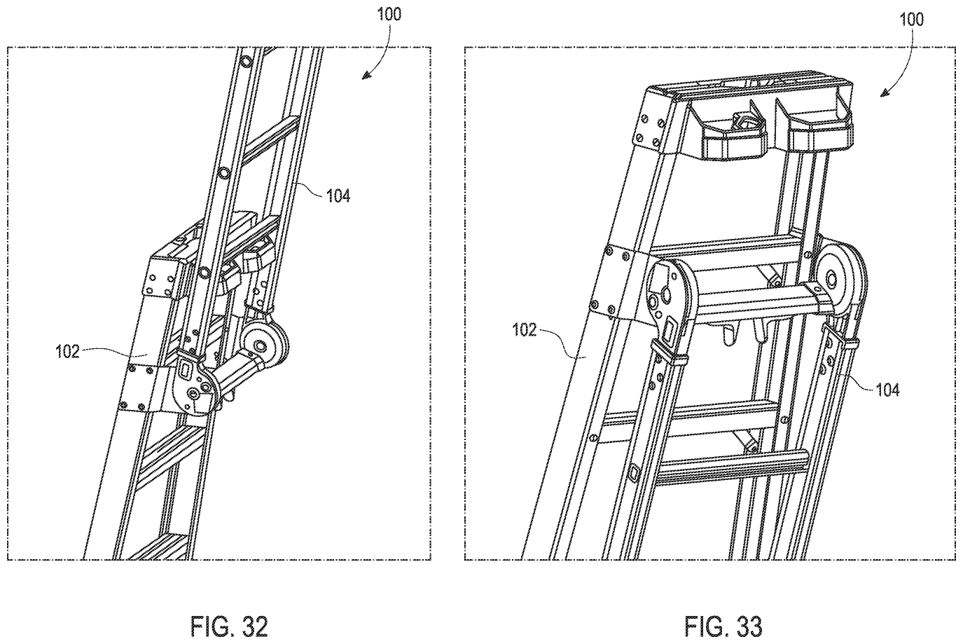

As shown generally in FIGS. 1-4, there is an exemplary ladder 100 that includes a lockable hinge assembly 110. The selectively lockable hinge assembly 110 enables a rear ladder section 104 of the ladder 100 to rotate or pivot relative to a front ladder section 102 to vary the angle between the rear ladder section 104 and the front ladder section 102 so that the ladder may be used in different positions. Specifically, the lockable hinge assembly 110 is unlockable or adjustable from a locked state to permit rotation of the rear ladder section 104 relative to the front ladder section 102 to change the angle therebetween and lockable or adjustable to a locked state to rotationally fix the rear ladder section 104 at a desired angle and position relative to the front ladder section 102, thereby preventing rotation of the sections relative to one another. For instance, in embodiments, the ladder 100 may be adjusted and locked into a stepladder position as shown in FIG. 1, a folded or lean-safe position (FIG. 33), or an extended straight position (FIG. 32). Other positions of the ladder are also possible, for example, an L or substantially L-shaped position of the ladder.

Advantageously, the lockable hinge assembly 110 includes a sliding lock assembly 116 that permits both hinges of the lockable hinge assembly 110 to be locked or unlocked manually at the same time by using one hand. The lockable hinge assembly 110 permits easy unlocking, adjusting, and locking of the ladder 100 into different positions. The lockable hinge assembly 110 also has minimal slack in the hinges which increases the longevity of the hinges, as explained further below.

The ladder 100 includes the first or front ladder section 102 and the second or rear ladder section 104. The front ladder section 102 includes a first rail 102a, a second rail 102b substantially parallel to the first rail 102a, and one or more steps or rungs 103 extending between the first rail 102a and the second rail 102b. The rear ladder section 104 includes a first rail 104a, a second rail 104b substantially parallel to the first rail 104a, and one or more steps or rungs 105 extending between the first rail 104a and the second rail 104b.

Though not present in the illustrated embodiment, in some embodiments the lengths of the rails 102a, 102b of the front ladder section 102 and/or the rails 104a, 104b of the rear ladder section 104 may be adjustable, for example by telescoping or sliding sets of rails.

As suggested, the rear ladder section 104 is rotatably coupled to the front ladder section 102 via the lockable hinge assembly 110. In embodiments, the lockable hinge assembly 110 may be positioned adjacent a top portion or just below a top portion of the front ladder section 102 and coupled thereto. Specifically, in some approaches, a first hinge 112 of the lockable hinge assembly 110 rotatably couples the first rail 104a of the rear ladder section 104 to the first rail 102a of the front ladder section 102 and a second hinge 114 of the lockable hinge assembly 110 rotatably couples the second rail 104b of the rear ladder section 104 to the second rail 102b of the front ladder section 102.

In one illustrative approach, the sliding lock assembly 116 of the lockable hinge assembly 110 extends between the first hinge 112 and the second hinge 114. The lock mechanism of the sliding lock assembly 116 is positioned within an interior of a hollow, elongate housing 120 of the sliding lock assembly 116. The housing 120 is coupled at one end to the first hinge 112 and at an opposite end to the second hinge 114. Specifically, the housing 120 is coupled to a first cover plate 136 of the first hinge 112 and a second cover plate 137 of the second hinge 114. Since the first cover plate 136 and the second cover plate 137 are rotationally fixed in position relative to the front ladder section 102, the sliding lock assembly is also rotationally fixed in position relative to the front ladder section 102.

The sliding lock assembly 116 includes an elongate fixed sliding plate 122, a first lock assembly 124 having a first locking bolt or pin 126 that engages the first hinge 112, and a second lock assembly 125 having a second locking bolt or pin 127 that engages the second hinge 114. In some configurations, the elements of the sliding lock assembly 116 are disposed in the housing 120. The sliding lock assembly 116 further includes a first actuator 117 and a second actuator 118 that extend, in part, below the fixed sliding plate 122 and the housing 120 such that they can be manually operated by a user. The first actuator 117 and the second actuator 118 are configured to actuate the first lock assembly 124 and the second lock assembly 125 to lock or unlock the first hinge 112 and the second hinge 114, respectively, as explained in further detail below.

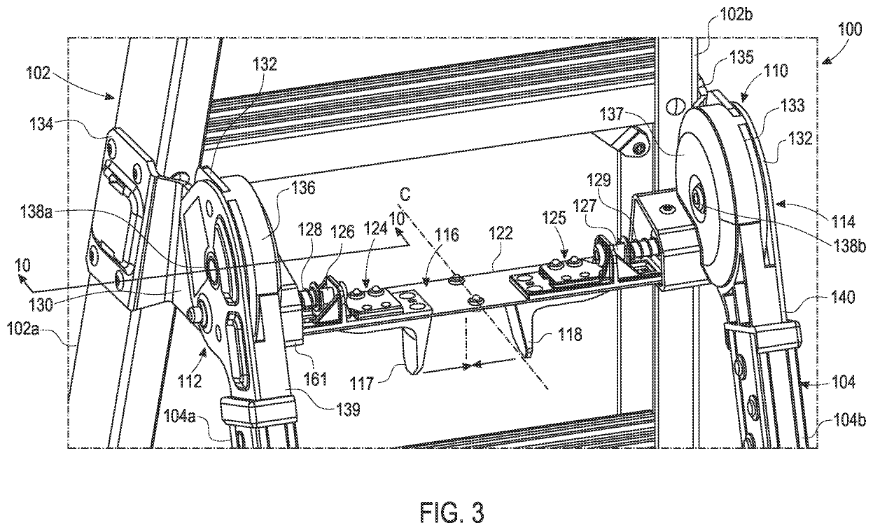

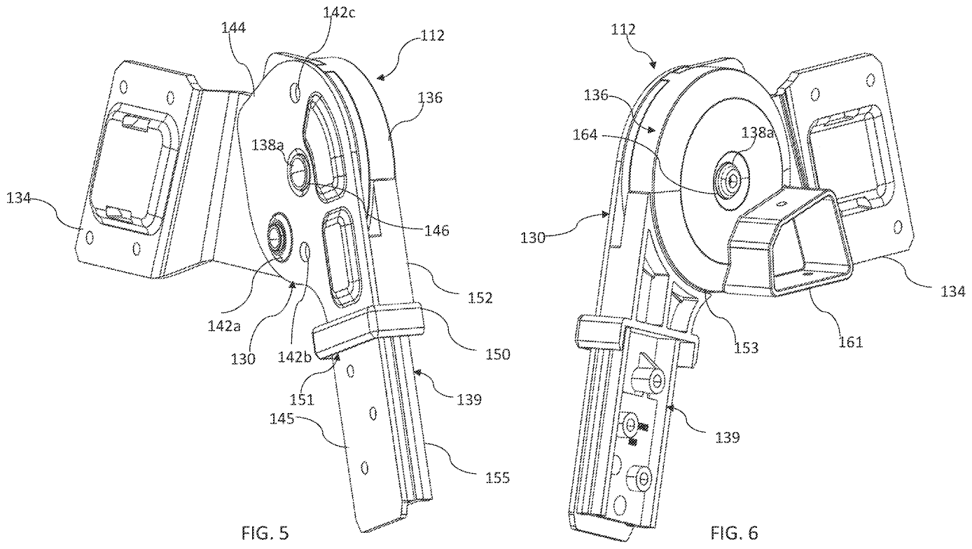

With reference to FIGS. 3-7, the first hinge 112 includes the cover plate 136, a stationary plate 132, and a rotational plate 130 coupled via pivot pin 138a, as well as a rotational support arm 139. The second hinge 114 likewise may include a cover plate 137, a stationary plate 133, and a rotational plate 131 coupled via pivot pin 138b, as well as a rotational support arm 140. Since the second hinge 114 typically mirrors the first hinge 112 and is substantially the same, only the first hinge 112 will be described in detail below.

In certain embodiments, the rotational plate 130 is the outermost plate of the first hinge 112, that is, is positioned on an outer-facing or external side of the first hinge 112 and the ladder 100. In such embodiments, the cover plate 136 is positioned on an inner-facing or internal side of the first hinge 112 and the ladder 100. In embodiments, the stationary plate 132 is sandwiched between the rotational plate 130 and the cover plate 136. A bracket portion 134 of the stationary plate 132 extends radially outward from the stationary plate 132. The stationary plate 132 is fixed to the first rail 102a of the front ladder section 102 via the bracket portion 134. The cover plate 136 is attached to the stationary plate 132 in such a manner that the cover plate 136 is fixed from rotation relative to the stationary plate 132. Thus, the cover plate 136 and the stationary plate 132 together constitute the stationary or fixed components of the first hinge 112.

The rotational plate 130 and the rotational support arm 139 constitute the rotational components of the first hinge 112. The rotational plate 130 is rotatably coupled to the stationary plate 132 and the cover plate 136 via the pivot pin 138a that extends between all three of the plates. Thus, the rotational plate 130 is configured to rotate relative to the stationary plate 132, the cover plate 136, and the front ladder section 102. The rotational support arm 139 is fixed to the rotational plate 130 and attaches to an end portion of the first rail 104a of the rear ladder section 104 so that the rotational plate 130, rotational support arm 139, and the first rail 104a rotate together.

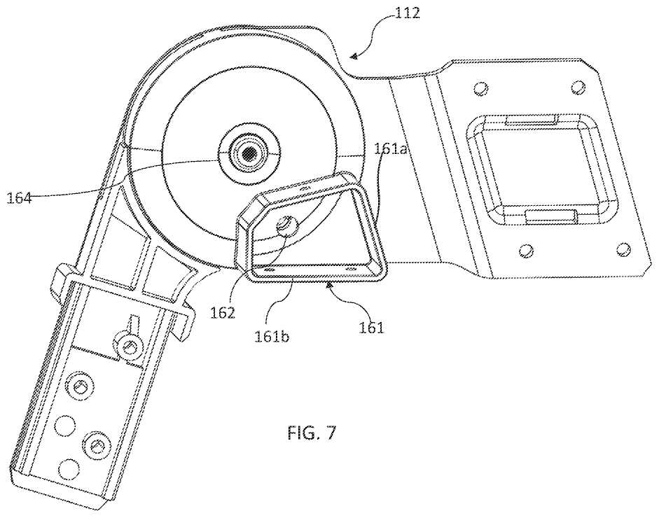

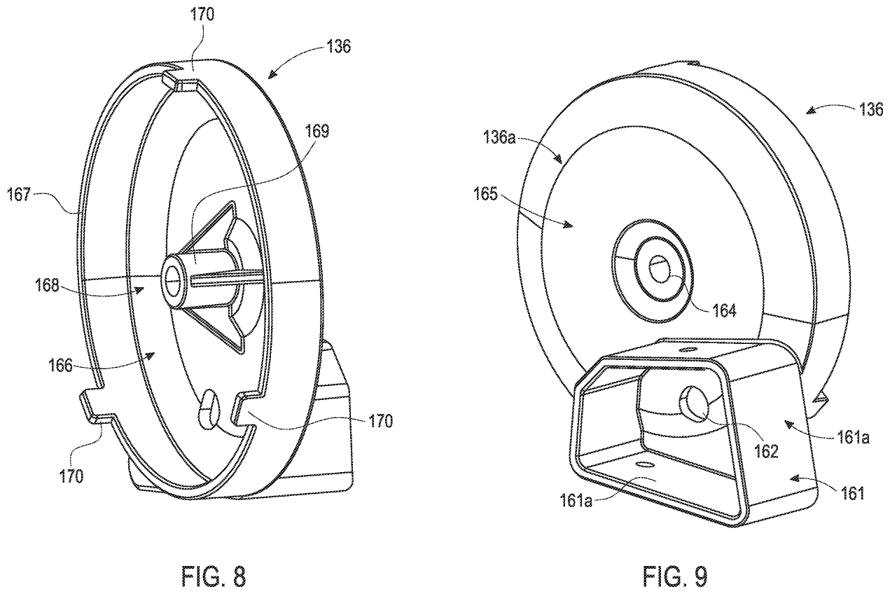

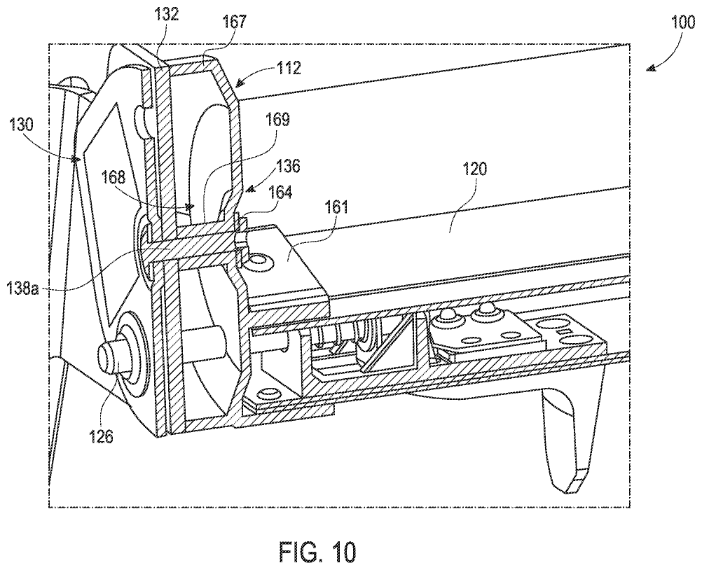

With reference to FIGS. 7-10, the cover plate 136 has a first outer side 165 that faces away from the rest of the first hinge 112 and a second inner side 166 that faces the stationary plate 132. In certain non-limiting embodiments, the cover plate 136 may be circular or rounded. A main disc portion 136a of the cover plate 136 may be generally planar or substantially flat In the illustrated embodiment, though the disc portion 136a is mostly flat, a perimeter region of the disc portion 136a may be slightly angled relative to a central region of the disc portion 136a, and, in particular, angled radially outward in the direction of the stationary plate 132 (See FIG. 10).

The cover plate 136 includes a pivot pin hole 164 for receiving the pivot pin 138a, which may be centrally disposed. The cover plate 136 also includes a locking pin hole 162 for receiving the locking bolt 126. In one approach, the locking pin hole 162 is disposed below the pivot pin hole 164 at a “bottom” portion of the main disc portion 136a of the cover plate 136 (as oriented when the ladder 100 is standing).

In some approaches the cover plate 136 may include a support channel 161 that projects axially from the outer side 165 about the locking pin hole 162 and functions to support the sliding lock assembly 116. In some embodiments, the support channel 161 may be defined in part by an annular wall 161a. A bottom portion of the annular wall 161a of the support channel 161 may define a supportive floor 161b of the support channel 161. The support channel 161 and annular wall 161a may have any suitable irregular or regular geometric shape and may have a portion that is offset from and extends radially outwards from the main disc portion 136a of the cover plate 136. Specifically, the support channel 161 may have a geometry corresponding to a geometry of the housing 120 of the sliding lock assembly 116. In this approach, an end of the housing 120 is sized and shaped to snugly fit within the support channel 161, supported by the floor 161b of the support channel 161. At least a portion of the sliding lock assembly 116 extends into the support channel 161, as explained further below, including the bolt 126 which extends through the support channel 161 and into the locking pin hole 162.

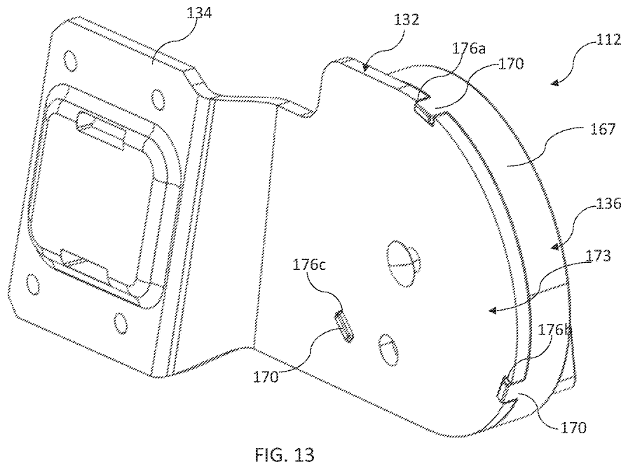

The second inner side 166 of the cover plate 136 may include an annular side wall 167 projecting axially from the perimeter of the main disc portion 136a which engages the stationary plate 132 (FIG. 13). The annular side wall 167 and the main disc portion 136a define a cavity 168 at the second inner side 166 of the cover plate 136. A channel 169 projects axially into the cavity 168 at the pivot pin hole 164 to support the pivot pin 138a as it extends through the cavity 168. As illustrated in FIG. 10, the channel 169 may abut the stationary plate 132 at a pivot pin hole 174 of the stationary plate 132, so that the pivot pin hole 164 of the cover plate 136 is aligned with the pivot pin hole 174 of the stationary plate 132.

By one non-limiting approach, the cover plate 136 may be a single molded component. For instance, the cover plate 136 in one example may be formed from a plastic such as polypropylene. The stationary plate 132 and the rotational plate 130 may be formed from aluminum or steel.

In some configurations, the annular side wall 167 includes one or more alignment tabs 170 that project axially from the annular side wall 167 to engage the stationary plate 134. The illustrated embodiment includes three tabs 170, though other quantities of the tabs 170 are possible. For instance, by one approach there is only one tab 170. In other non-limiting approaches there may be two, four, or six tabs 170. When there are a plurality of tabs 170, the tabs 170 may be spaced about the annular side wall 167. One function of the tabs 170 is to align and fix the cover plate 136 from rotation relative to the stationary plate 132. To this end, a main disc portion 173 of the stationary plate 132 includes notches, slots, or cut-outs 176 that correspond to the tabs 170. The tabs 170 are received through the notches or slots 176 so that the cover plate 136 is fixed from rotation relative to the stationary plate 132. The tabs 170 and notches or slots 176 are also precisely positioned so that proper alignment is attained between the locking pin hole 162 of the cover plate 136 and a corresponding locking pin hole 175 of the stationary plate 132. The tabs 70 and notches or slots 176 may be generally rectangular in shape, though other geometries are also contemplated.

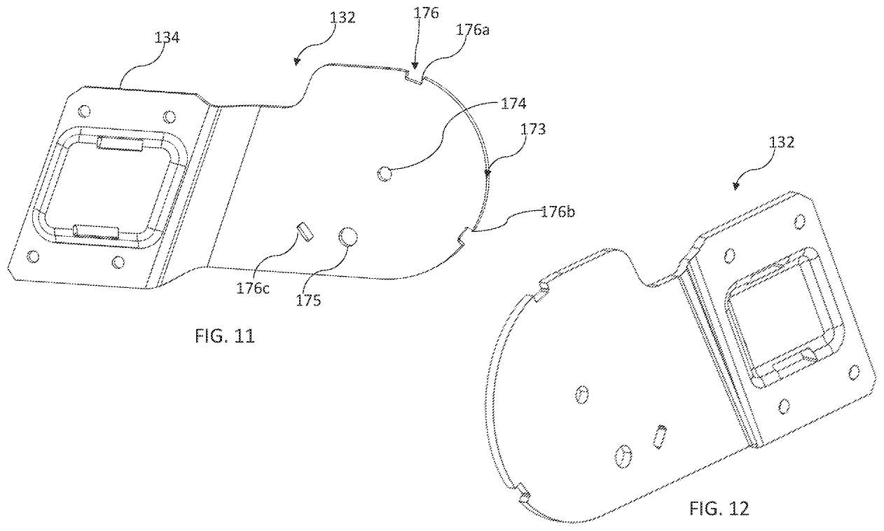

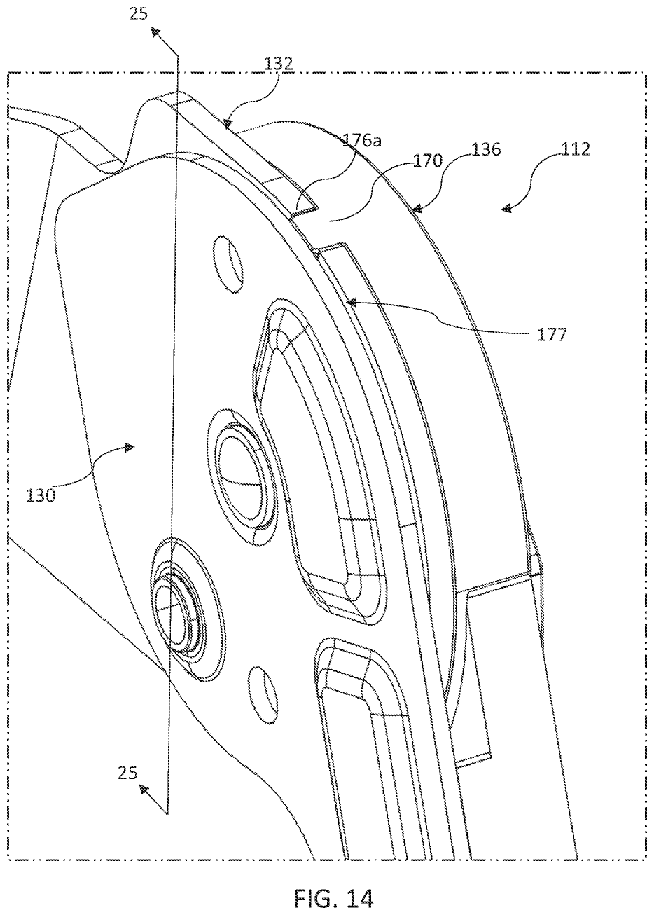

With reference to FIGS. 11-14, some of the notches or slots 176 may be positioned on the perimeter of the stationary plate 132 while others may not be positioned on the perimeter. For instance, in the illustrated embodiment, notches 176a and 176b may be on the perimeter of the main disc portion 173 of the stationary plate and are positioned to engage two of the tabs 170 at the perimeter of the cover plate 136. A slot 176c, however, may be disposed radially inward from the perimeter of the stationary plate 132 so that it can engage a third of the tabs 170. A radially inward slot 176c of the stationary plate 132 may be used, for example, in areas where the perimeters of the stationary plate 132 and the cover plate 136 do not correspond to one another.

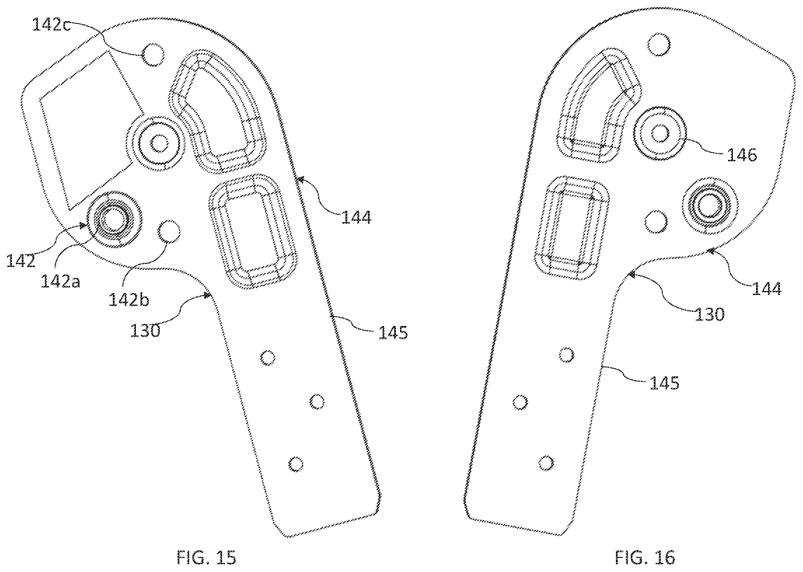

A further function of the tabs 170 and notches or slots 176 is to space the stationary plate 132 from the rotational plate 130. This is shown most clearly in FIG. 15. An axial length of the tabs 170 is slightly longer than a corresponding axial length of the notches or slots 176 so that the tabs 170 extend slightly past the notches or slots 176 when they are inserted therein. When assembled in the hinge 112, the rotational plate 130 contacts or engages the tabs 170 of the cover plate 136 instead of directly contacting or engaging the stationary plate 132. A gap 177 is present between the rotational plate 130 and the stationary plate 132. Because the rotational plate 130 does not contact the stationary plate 132, and has only a small amount of contact with the tabs 170 of the cover plate 136, friction is minimized during rotation of the rotational plate 130.

As illustrated in FIGS. 11-13, the stationary plate 132 includes the main disc portion 173 which is disposed between the rotational plate 130 and the cover plate 136 and the bracket portion 134 which extends radially from the main disc portion 173. The bracket portion 134 attaches the stationary plate 132 to the first rail 102a of the front ladder section 102. The stationary plate 132 includes a pivot pin hole 174 for the pivot pin 138a to pass through and a locking pin hole 175 as discussed above.

With reference to FIGS. 15 and 16, the rotational plate 130 includes a main disc portion 144 and an elongate portion 145 extending from the main disc portion 144. The main disc portion 144 may be substantially rounded and is axially aligned with the main disc portion 173 of the stationary plate 132 and the main disc portion 136a of the cover plate 136. The main disc portion 144 includes a pivot pin hole 146 to rotatably couple the rotational plate 130 to the rest of the hinge 112. The main disc portion 144 also includes a plurality of locking holes 142 spaced radially outward from the pivot pin hole 146. The locking holes 142 correspond to different positions of the ladder 100. For instance, in the illustrated embodiment, when the bolt 126 is locked into locking hole 142a, the ladder 100 is in an A-line or stepladder position (FIG. 1), when the bolt 126 is locked into locking hole 142b, the ladder 100 is in a folded or lean-safe position (FIG. 33), and when the bolt 126 is locked into locking hole 142c, the ladder 100 is in an extended straight position (FIG. 32). In use, the position of the ladder 100 is changed by rotating the rotational plate 130 on the first hinge 112 to align the bolt 126 with the locking hole 142 corresponding to the desired position. Other positions of the ladder besides the three illustrated positions, as well as a different quantities of locking holes 142 are also contemplated.

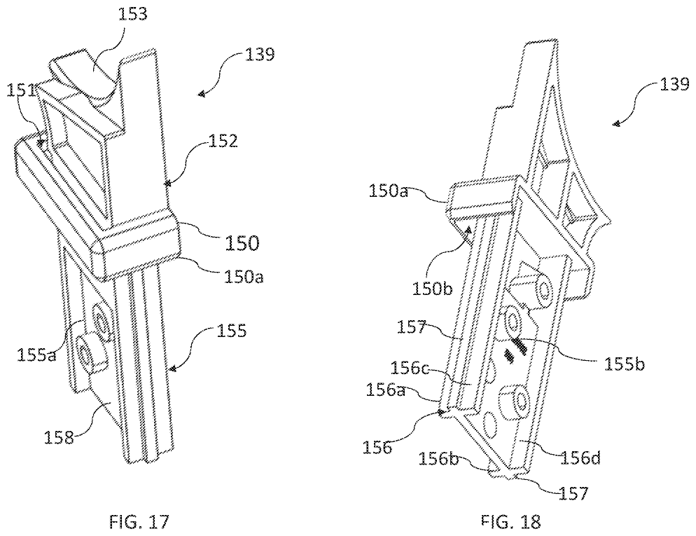

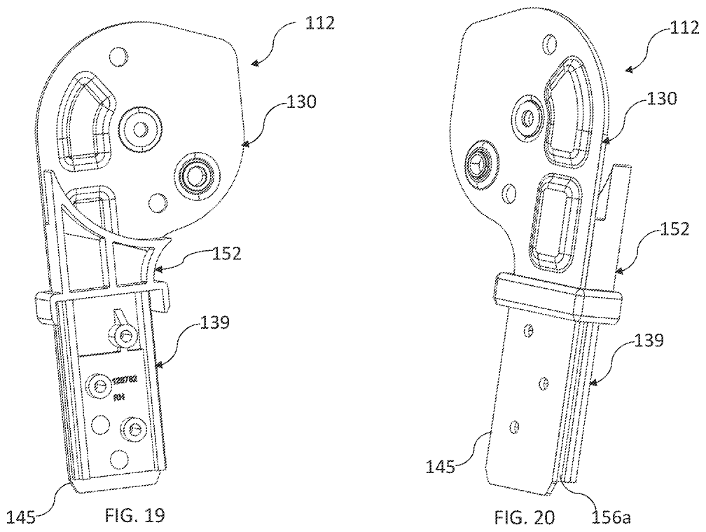

With reference to FIGS. 17-22, the elongate portion 145 of the rotational plate 130 is coupled to the rotational support arm 139, which are together configured to be received within the first rail 104a of the rear ladder section 104 and coupled thereto. The rotational support arm 139 includes a first “upper” portion 152 that is disposed closest to the disc portions 144, 173, 136a of the rotational plate 130, stationary plate 132, and cover plate 136, respectively, and a second “lower” rail insert portion 155. A flange 150 is disposed therebetween.

The first upper portion 152 positioned above the flange 150 and terminates in part in an arcuate surface 153 that corresponds to a curvature of the cover plate 136. In some embodiments, the arcuate surface 153 is spaced from the disc portion 144 of the rotational plate 130 so that the arcuate surface 153 is directly below the cover plate 136 and not the stationary plate 132. In embodiments, the arcuate surface 153, and the rotational support arm 139 more generally, support the hinge 112 and guide rotation of the rotational components of the hinge 112 relative to the cover plate 136. In the stepladder position of the ladder 100 in particular, the arcuate surface 153 positioned underneath the cover plate 136 provides extra support to the cover plate 136 (and the sliding lock assembly 116 coupled thereto), as well as the hinge 112 altogether.

The flange 150 extends outwardly between the first upper portion 152 and the lower rail insert portion 155. For instance, in the illustrated embodiment, the flange 150 projects from three contiguous sides at a base of the first upper portion 152. A downturned rim 150a projects downwardly from the flange 150 towards the lower rail insert portion 155, defining a pocket or receptacle 150b between the downturned rim 150a and the lower rail insert portion 155 for receiving an end portion of the first rail 104a of the rear ladder section 104. In some embodiments, there may be a slight friction fit between portions of the flange 150 or downturned rim 150a and the first rail 104a.

A slot 151 is defined between the flange 150 and the base of the first upper portion 152 at an external-facing side of the rotational support arm 139. The slot 151 is sized to receive the elongate portion 145 of the rotational plate 130, the elongate portion 145 extending therethrough and aligning with the lower rail insert portion 155 of the rotational support arm 139.

The lower rail insert portion 155 is defined by a generally planar or flat plate portion 158 that may be generally rectangular and a plurality of longitudinal flanges 156 that project from both the outward facing side 155a and the inward facing side 155b of the flat plate portion 158. In the illustrated embodiment, for example, the outward facing side 155a includes a first longitudinal flange 156a projecting along an entire length of a side edge of the lower rail insert portion 155 and a second longitudinal flange 156b projecting along an entire length of an opposite side edge of the lower rail insert portion 155. Likewise, the inward facing side 155b includes a third longitudinal flange 156c and a fourth longitudinal flange 156d projecting along entire lengths of opposing side edges. The longitudinal flanges 156 may, for example, project substantially perpendicularly from the flat plate portion 158. In addition, in certain embodiments the lower rail insert portion 155 may define first and second longitudinal ribs 157 that project outwardly from the lower rail insert portion 155 between the first and third longitudinal flanges 156a, 156c and between the second and fourth longitudinal flanges 156b, 156d, respectively. The length of the longitudinal ribs 157 may also extend the entire length or substantially the entire length of the lower rail insert portion 155.

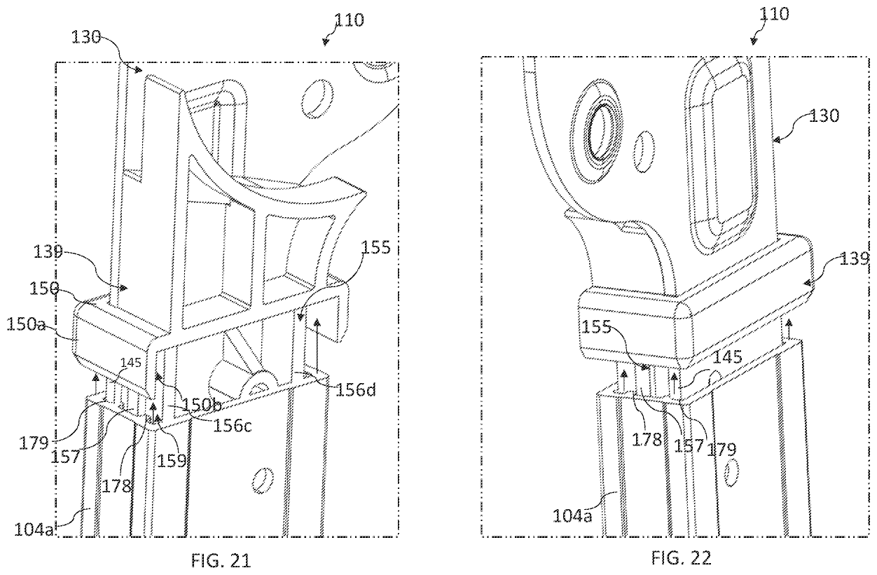

As illustrated best in FIGS. 21 and 22, when the lower rail insert portion 155 is inserted into the first rail 104a, the longitudinal flanges 156 and longitudinal ribs 157 of the lower rail insert portion 155 define channels 159 therebetween to align with and engage corresponding longitudinal ridges 178 disposed along the length of the first rail 104a. For instance, the longitudinal ridges 178 may be received in the channels 159 defined by the longitudinal flanges 156 and longitudinal ribs 157 to properly align the lower rail insert portion 155 within the first rail 104a.

In some embodiments, one or more recesses 179 in the first rail 104a defined between the longitudinal ridges 178 of the first rail 104a are positioned to receive the longitudinal ribs 157 of the lower rail insert portion 155 and/or positioned to receive the elongate portion 145 of the rotational plate 130.

By one approach, when fully assembled, the lower rail insert portion 155 and the elongate portion 145 of the rotational plate 130 are received within the first rail 104a and a terminal end of the first rail 104a is received within the pocket 150b defined by the downturned rim 150a of the flange 150. The rotational plate 130, the lower rail insert portion 155 of the rotational support arm 139, and the first rail 104a may be fixed to one another, for example, via bolts, screws, or other fasteners extending through corresponding holes in each component. Other attachment methods are also contemplated.

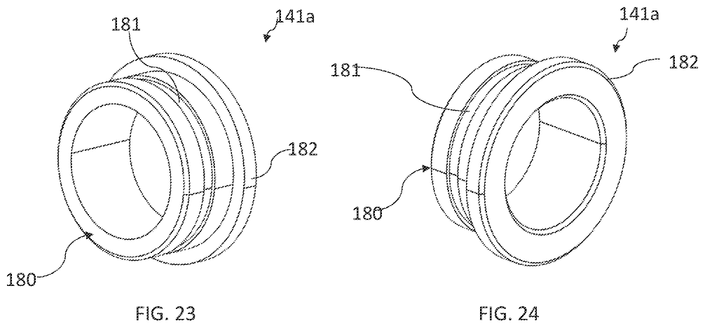

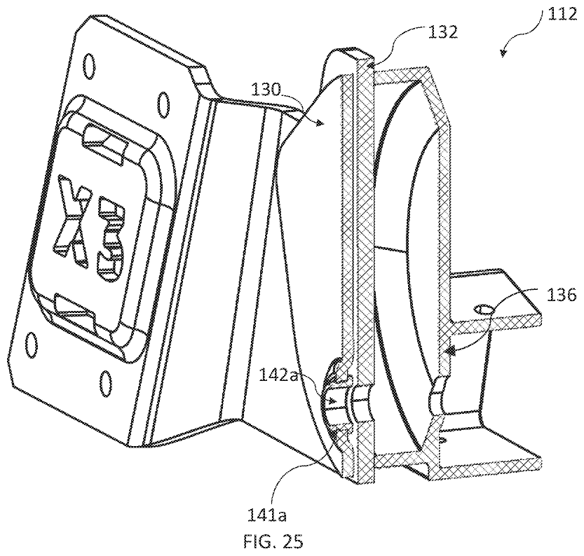

With reference to FIGS. 23-27, the rotational plate 130 may further include a bushing 141a disposed in at least one of the locking holes 142. In an illustrative embodiment, the bushing 141a is present in the locking hole 142a which corresponds to the stepladder position. Typically, locking holes that correspond to a stepladder position experience extra strain and impact during use of the ladder in the stepladder position compared to the locking holes corresponding to the folding position or the extended position. Specifically, the bolt 126 crashing into the locking hole in the stepladder position causes the strain and impact, which can deform the locking hole over time, leading to increased slack in the hinge.

In embodiments, the bushing 141a is made of a hard metal such as, for example, machined steel, and is installed in a hole 186 in the rotational plate 130 to define the locking hole 142a. With the bushing 141a in the locking hole 142a, the locking hole 142a is reinforced and experiences reduced deformation over time. For instance, in an illustrative embodiment, the locking hole 142a with the bushing installed 141a can undergo at least 6,000 cycles before deformation occurs, wherein a “cycle” includes configuring a ladder from a closed position to a stepladder position, to a straight extended position, back to the stepladder position, and then back to the closed position.

By one approach, the portion of the rotational plate 130 immediately surrounding the hole 186 that receives the bushing 141a includes an annular protruding arched portion 183 about the hole 186. This arched portion 183 of the rotational plate 130 helps to space the bushing 141a disposed in the hole 186 away from contact with the stationary plate 132. In some embodiments, an annular depression or recess 184 may be disposed immediately radially inward from the annular protruding arch 183 about the hole 186. In addition, an annular rib or bead 185 may extend at an angle from the depression 184 about the hole 186.

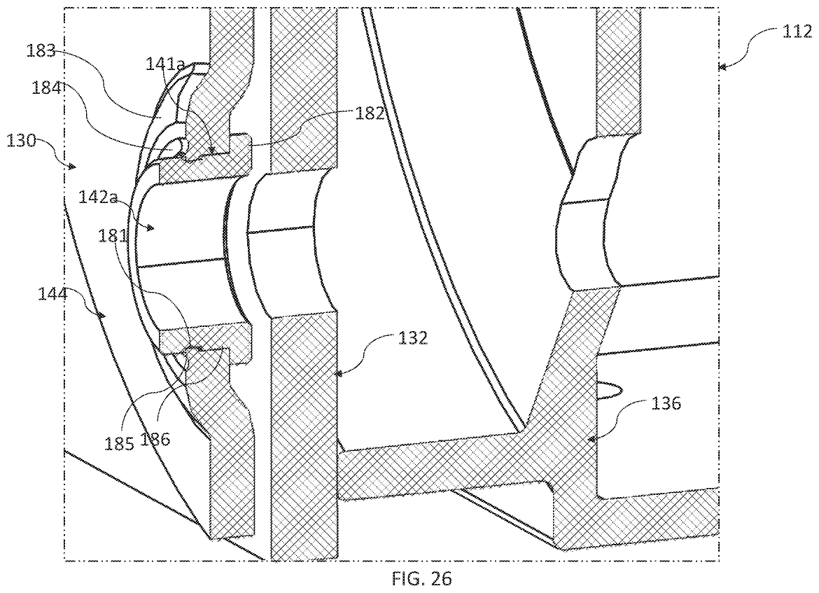

The bushing 141a has an annular body 180 that includes an annular flange 182 extending radially from the bushing 141a at one end of the bushing 141a. The body 180 further includes an annular recess 181. As illustrated best in FIGS. 26 and 27, the annular flange 182 contacts or abuts an inward-facing side of the rotational plate 130, and is spaced from the stationary plate 132. The annular recess 181 is sized to captivate the annular rib or bead 185 positioned about the hole 186 in the rotational plate 130. In some embodiments, the bushing 141a may simply be pressed into the hole 186 of the rotational plate 130 during assembly, with the annular recess 181 captivating the annular rib 185 to lock the bushing 141a in place.

In certain approaches it is advantageous to have the rotational plate 130 positioned externally on the hinge 112 and the stationary plate 132 and the cover plate 136 positioned inwardly towards the sliding lock assembly 116. In this configuration, the bolt 126 only needs to disengage and engage the rotational plate 130 during unlocking and locking, and remains extending through the respective locking pin holes 162, 175 of the cover plate 136 and the stationary plate 132 at all times. Since the bolt 126 never needs to be removed from the stationary plate 132 and the cover plate 136, the locking pin holes 162, 175 in these plates can be configured very precisely so that there is a reduced amount of play or slop between the bolt and the locking pin holes 162, 175. Further, since the bolt never disengages from the stationary plate 132 and the cover plate 136, this means that the bolt 126 and locking holes 142 of the rotational plate 130 can also be precisely dimensioned to correspond to one another to reduce slop in the hinge 112.

Another benefit of the rotational plate 130 being positioned externally on the hinge 112, with the locking holes 142 extending entirely through the rotational plate 130 and exposed externally, is that the user is able to see the bolt 126 disengage and engage the locking holes 142 during reconfiguration of the ladder. This can help the user adjust the ladder to the correct position and give the user confidence that the ladder is properly locked. By one approach, the bolt 126 is long enough so that the bolt protrudes from the locking holes 142 when locked. In certain embodiments, the user can both see and hear the bolt clicking into the locking holes 142 to lock the ladder into position.

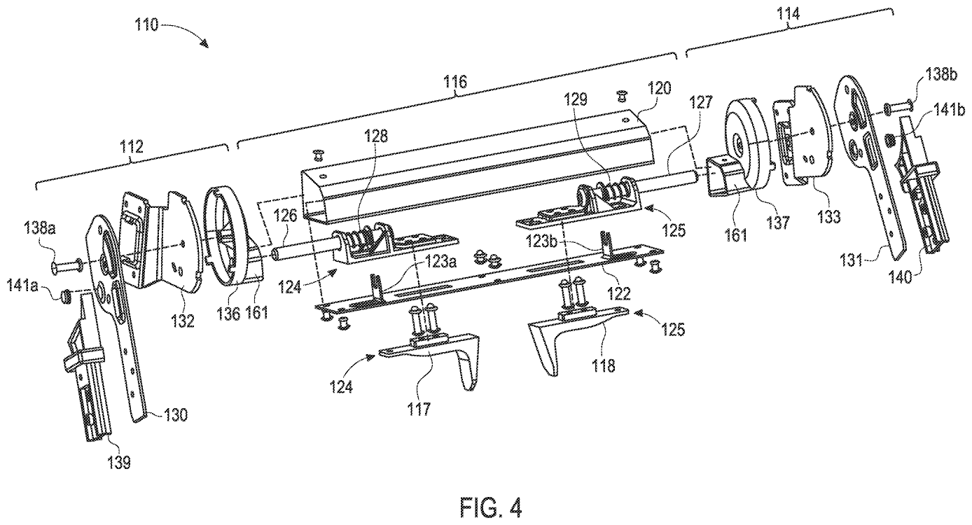

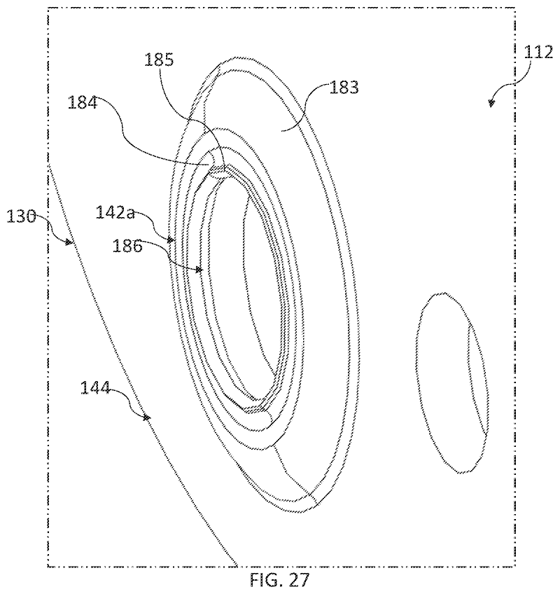

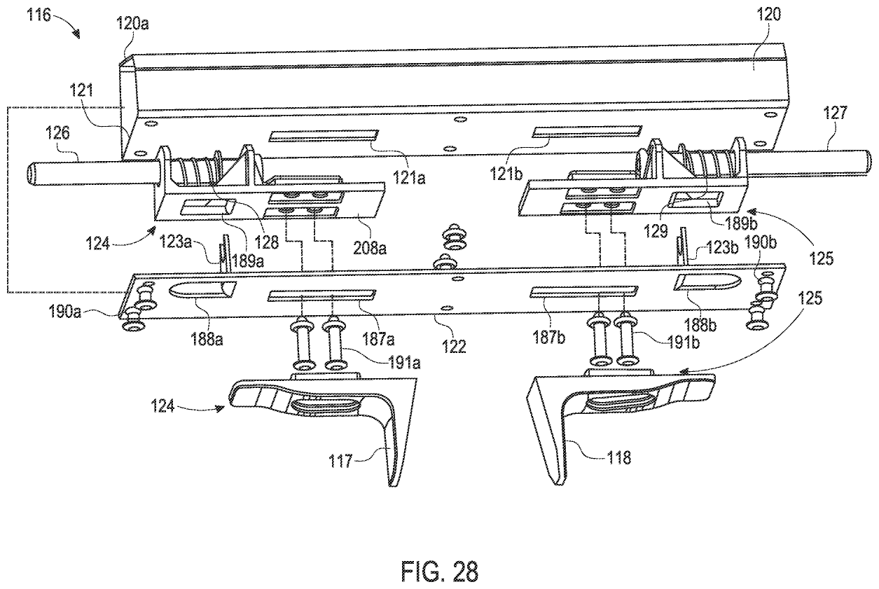

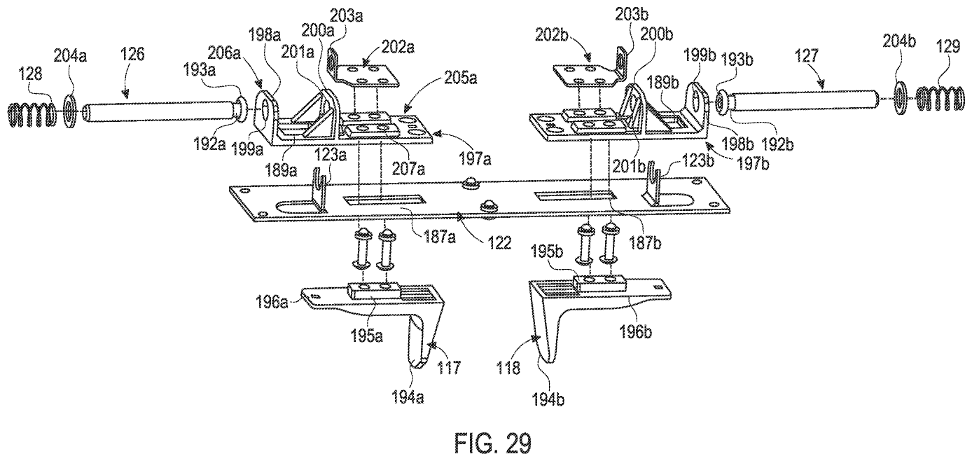

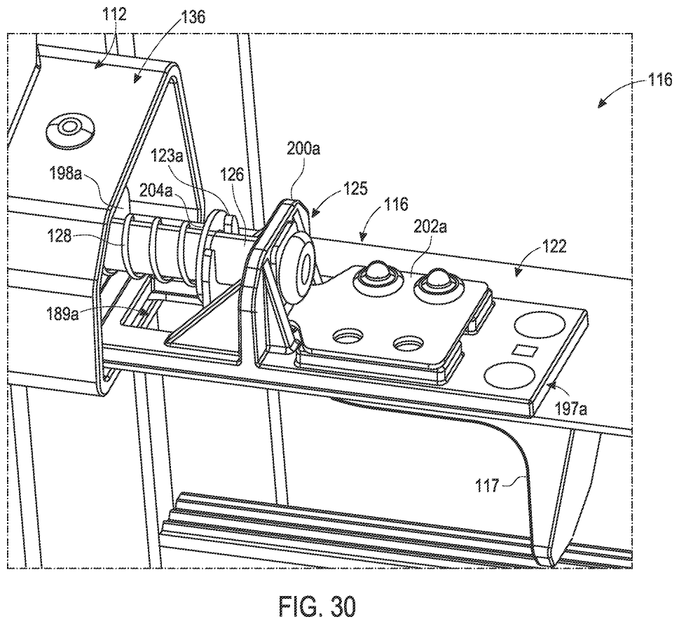

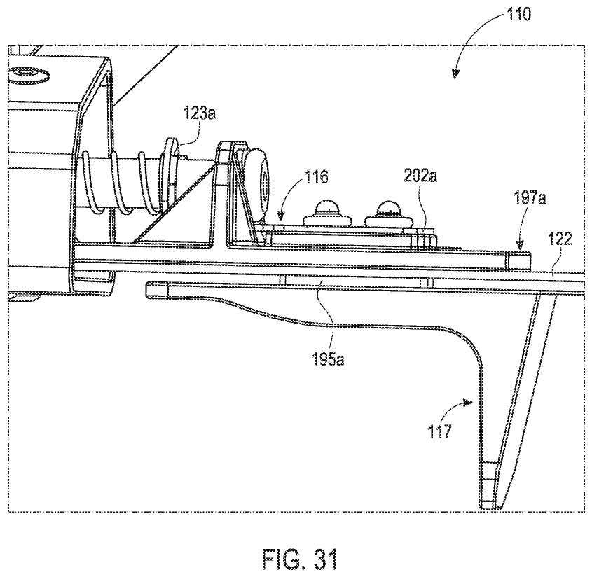

With reference to FIGS. 4 and 28-31, the sliding lock assembly 116 includes an elongate hollow housing 120 that, as noted above, has a first open end coupled to the support channel 161 of the cover plate 136 of the first hinge 112 and a second open end coupled to the support channel 161 of the cover plate 137 of the second hinge 114. When coupled in this manner, the hollow interior of the housing 120 is continuous with the interiors of the support channels 161 of each hinge 112, 114. In one approach, the housing 120 obscures all of the sliding lock assembly 116 from view except for the actuators 117, 118. The housing 120 includes an elongate planar or flat bottom or base 121 that has first and second open ends seated on and coupled to the respective floors 161b of the support channels 161 of the first and second hinges 112, 114. An elongate top portion 120a of the housing 120 may also be coupled to the support channels 161 at each end (e.g., using bolts, screws, or other fasteners.).

The housing 120 further includes first and second elongate slots 121a, 121b in the base 121 that are sized and positioned to correspond to first and second elongate slots 187a, 187b in the fixed sliding plate 122. The elongate slots 121a, 121b in the base 121 of the housing 120 and the elongate slots 187a, 187b in the fixed sliding plate 122 permit the axial movement of the actuators 117, 118 external to the housing 120 to actuate the sliding lock assembly 116 to lock and unlock the hinges 112, 114.

The sliding plate 122 seats on the base 121 of the housing 120 and may be sized similarly to the base 121 so that it extends from the first hinge 112 to the second hinge 114 within the housing 120. The sliding plate 122 may be coupled to the housing 120 and the support channels 161 of the cover plates 136, 137 via fasteners 190a, 190b. A first lock assembly 124 is positioned on a first side of the sliding plate 122 to engage the first hinge 112 while a second lock assembly 125 is positioned on a second side of the sliding plate 122 to engage the second hinge 114. The first elongate slot 187a of the sliding plate 122 is engaged by the first lock assembly 124 while the second elongate slot 187b of the sliding plate 122 is engaged by the second lock assembly 125. The sliding plate 122 may further include additional openings 188a and 188b positioned between the first elongate slot 187a and the first hinge 112 and between the second elongate slot 188b and the second hinge 114, respectively.

The sliding plate 122 further includes first and second stops or bearing surfaces 123a, 123b projecting upwardly from the sliding plate 122. The first stop 123a projects from the sliding plate 122 at an inwardly oriented end of the opening 188a and the second stop 123b projects from the sliding plate 122 at an inwardly oriented end of the opening 188b. Each of the stops 123a, 123b defines a rounded groove that the bolts 126, 127, respectively, can pass through and be supported by. The upwardly extending sides of the groove on each stop 123a, 123b function to stop movement of each of the first lock assembly 124 and the second lock assembly 125 in the direction of the center line C (FIG. 3) of the sliding lock assembly 116, as explained further below.

The first lock assembly 124 includes the actuator 117 which is disposed below the housing 120 and moves along an external surface of the base 121. The actuator 117 includes a generally planar or flat base 196a that may engage the external surface of the base 121 and a handle 194a projecting downwardly towards the base. Pushing the handle so the actuator 117 moves or slides towards the center line C of the sliding lock assembly 116 unlocks the hinge 112, while releasing the handle so the actuator 117 moves or slides in the reverse direction locks the hinge 112. The actuator includes a projection 195a that extends upwardly from the flat base 196a and into the slot 187a, sized to move within the slot 187a. Fasteners 191a may fasten the projection 195a of the actuator 117 to the portions of the first lock assembly 124 disposed above the slot 187a. In some approaches, the projection 195a may also function as a stop for the first lock assembly 124 within the slot 187a. That is, the actuator 117 is inhibited from further motion towards the center line C when the projection 195a abuts an end of the slot 187a.

In some embodiments, the portion of the first lock assembly 124 above the sliding plate 122 includes a moving plate 197a, an upper plate 202a that seats on top of the moving plate 197a, the bolt 126 carried by the moving plate 197a, and an elastomeric biasing member 128 such as a compression spring to bias the first lock assembly 124 into a locked position of the first hinge 112.

The moving plate 197a has a generally planar or flat base 208a that is wider than the slot 187a so that it can slide on the sliding plate 122 on both slides of the slot 187a. A first end portion 205a of the moving plate 197a is coupled to the actuator 117 so that moving the actuator 117 also moves the moving plate 197a. Specifically, one or more fasteners 191a extend through the projection 195a in the actuator 117, through the slot 187a, and into corresponding passages 207a for the fasteners 191a at the first end portion 205a of the moving plate 197a. The fasteners 191a may also extend through corresponding passages of the upper plate 202a that seats on top of the moving plate 197a at the first end portion 205a. The upper plate 202a includes an upper plate flange 203a that projects upwardly from the upper plate 202a and having a hole for the bolt 126 to extend therethrough. The bolt 126 may have a wider head 193 at a terminal end thereof positioned on one side of the upper plate flange 203a and unable to pass through the hole of the upper plate flange 203a. The bolt 126 may also have an annular recess 192 adjacent the head 193 that is sized to seat within the hole of the upper plate flange 203a.

A second end portion 206a of the moving plate 197a includes a first flange 198a that projects upwardly from a terminal end of the moving plate 197a and a second flange 200a spaced from the first flange 198a that projects upwardly from the moving plate 197a between the first flange 198a and the upper plate flange 203a of the upper plate 202a. Both the first flange 198a and the second flange 200a have respective holes 199a, 201a that are aligned so that the bolt 126 can extend therethrough. The holes 199a and 201a are also aligned with the hole of the upper plate flange 203a. The bolt 126 extends between the first flange 198a and the second flange 200a, with the wider head 193 of the bolt 126 being disposed on an opposite side of the second flange 200a and past the upper plate flange 203a, as explained above. A portion of the bolt 126 also extends through and past the first flange 198s towards the first hinge 112 so that it can be drawn into or out of the hinge 112 to lock or unlock the hinge 112.

The moving plate 197a includes an elongate opening 189a between the first flange 198a and the second flange 200a. The moving plate 197a is positioned on the sliding plate 122 so that the stop 123a projecting from the sliding plate 122 extends upwardly into the elongate opening 189a so that the bolt 126 is supported by and passes through the groove of the stop 123a. The spring 128 is disposed around the bolt 126 between the first flange 198a and the stop 123a. Specifically, the first flange 198a and the sides of the groove of the stop 123a retain the spring 128 therebetween. As illustrated, a washer 204a may also be present on the bolt 126 between the stop 123a and the spring 128 to further retain the spring 128 and provide a further bearing surface for compression of the spring 128.

The spring 128 in its uncompressed state, extending in tension between the stop 123a (and washer 204a) and the first flange 198a, biases the first lock assembly 124 in the locked condition of the sliding lock assembly 116 and the first hinge 112. In this condition, the first lock assembly 124 is positioned close enough to the first hinge 112 that the bolt 126 extends through the respective locking holes of the cover plate 136, the stationary plate 132, and the rotational plate 130, so that the rotational plate 130 is locked in position relative to the rest of the hinge 112 and inhibited from rotation. In the locked condition, a portion of the moving plate 197a, including the first flange 198a, is held in tension by the spring 128 within the support channel 161 of the cover plate 136 so that the bolt 126 is drawn through the entire hinge 112.

To unlock the first hinge 112 to enable rotation of the rotational plate 130 relative to the rest of the hinge 112, the actuator 117 is moved towards the center line C at a force sufficient to overcome the biasing of the spring 128. Moving the actuator 117 towards the center line C draws the entire first lock assembly 124 along the sliding plate 122 towards the center line C until the bolt 126 is drawn out of the locking hole 142 of the rotational plate 130.

More specifically, when the first lock assembly 124 is moved towards the center line C due to the force applied to the sliding actuator 117, the first flange 198a of the moving plate 197a is drawn towards the stop 123a (and washer 204a if present). The spring 128, extending between the first flange 198a and the stop 123a, is thus compressed by the first flange 198a as the first flange 198a is drawn towards the stop 123a. When force is no longer applied to the actuator 117, the spring 128 quickly returns to its uncompressed state, drawing the entire first lock assembly 124 back towards the hinge 112 so that the bolt 126 can once again engage a locking hole 142 of the rotational plate 130 to lock rotation of the rotational plate 130 relative to the rest of the hinge 112.

As noted above, in some approaches the bolt 126 never becomes disengaged from the locking pin holes 162, 175 of the cover plate 136 and the stationary plate 132 during unlocking. Instead, the bolt 126 only disengages from the locking holes 142 of the rotational plate 130 during unlocking. This is advantageous because it simplifies design since there is no need to account for different tolerances in the locking holes of all the components that may impede movement of the bolt 126.

The second lock assembly 125 is substantially the same as the first lock assembly 124 yet engages the second hinge 114 instead of the first hinge 112. The second lock assembly 125, like the first lock assembly 124, includes an actuator 118, a moving plate 197b, a locking bolt 127, and an elastomeric biasing element such as a spring 129. The second lock assembly 125 also includes all the other components specified above with respect to the first lock assembly, annotated in the figures with the same reference number as those used for the first lock assembly but with a “b” instead of “a”. For instance, the upper plate 202b in the second lock assembly 125 corresponds to the upper plate 202a in the first lock assembly 124. The entire description of the components and functioning of the first lock assembly 124 is incorporated by reference for the components of the second lock assembly 125.

It will be appreciated that, in use, the first hinge 112 and the second hinge 114 must be unlocked at the same time to enable rotation of the rotational plates 130, 131 relative to the hinges 112, 114, since rotational plates 130, 131 are both coupled to the rear ladder section 104 and thus move together, Thus, unlocking a ladder 100 from its current position to change the position of the ladder 100 requires using the sliding lock assembly 116 to unlock both hinges 112, 114. To do so, the actuators 117, 118 are both moved towards each other and towards the center line C of the sliding lock assembly to draw the bolts 126, 127 out of the respective rotational plates 130, 131 of each hinge 112, 114 simultaneously or nearly simultaneously. In an illustrative approach, the actuators 117, 118 are positioned close enough together so that a user can grasp both actuators 117, 118 in one hand and squeeze them towards each other to unlock the hinges 112, 114. The user can then grasp the rear ladder section 104 to rotate the rear ladder section 104 relative to the front ladder section 102 to the desired position. The hinges 112, 114 are re-locked when the actuators 117, 118 have been released and the springs 128, 129 draw the bolts 126, 127 back into a locking hole 142 of the rotational plates 130, 131 of each hinge 112, 114 corresponding to the desired position of the ladder 100.

The ladder 100 and lockable hinge assembly 110 described above may, in certain embodiments, be modified to include any of the below-described mechanisms to further eliminate slack in the hinges 112, 114. Specifically, the below mechanisms eliminate slack in a ladder hinge by applying a continuous force between the rotational or moving plate of the hinge (e.g., rotational plate 130) and the stationary or fixed plate (e.g., stationary plate 132).

Generally speaking, the below mechanisms for removing slack in a hinge may be applied to any hinge for a ladder that includes a rotational plate rotatably coupled to a stationary plate. In embodiments, the hinge includes a stationary plate attached to the first front rail and a rotational plate attached to the first rear rail, rotatably coupled to the stationary plate. The first rear rail is able to be rotated to a desired position relative to the first front rail by the rotational plate rotating relative to the stationary plate. The hinge includes a hinge lock which locks the rotational plate relative to the stationary plate so that the ladder is locked in the desired position. The hinge includes at least one slack removing mechanism in contact with the rotational plate and the stationary plate to remove or reduce slack between the rotational plate and the stationary plate when the rotational plate is locked in the desired position. The same configuration can be applied to a second hinge that rotates a second rear rail relative to a second front rail.

In embodiments, the slack removing mechanisms can be described as creating a constant tension between a stationary plate and a rotational plate of the hinge when the hinge is locked. By maintaining a tension between the rotational plate and the stationary plate, slack is reduced or removed between them, reducing movement or jiggle between the rotational plate and the stationary plate when they are locked during transportation or use by a person standing on the ladder. By certain approaches, the slack removing mechanisms include a spring and/or a wedge/cam to create the tension between the rotational plate and the stationary plate.

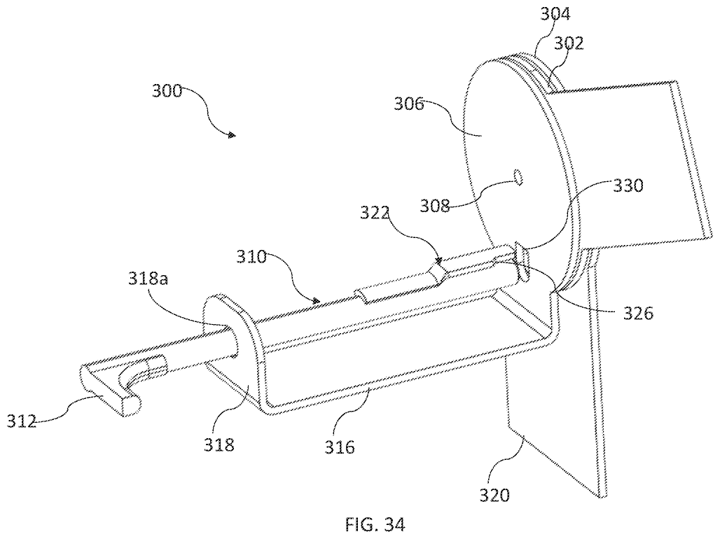

With reference to FIG. 34, there is a hinge assembly 300 for a ladder that has reduced or eliminated slack. As shown, the hinge assembly includes a first stationary plate 306, a second stationary plate 304, and a rotational plate 302 sandwiched therebetween. It will be appreciated, however, that the hinge assembly 300 may also have the second stationary plate 304 sandwiched between the first stationary plate 306 and the rotational plate 302 like in hinge assembly 110, with the rotational plate 302 disposed on an external side of the hinge. The stationary plates 304 and 306 are fixed relative to a front rail of the ladder. For instance, at least one of the stationary plates 304, 306 may have a front bracket that attaches to the front rail. The rotational plate 302 is attached to a rear rail, for example, via a rear bracket. The three plates are coupled together via a central pivot 308, with the rotational plate 302 able to rotate relative to the stationary plates 304, 306 to change a position of the ladder, as described above.

To lock the rotational plate 304 into a position relative to the stationary plates 304, 306, a bolt 310 is positioned to move axially through the locking holes in all three of the plates. In one embodiment, a bolt bracket 316 may extend inwardly from a bottom of the innermost stationary plate 306, the bolt bracket 316 including a flange 318 at an end thereof. The flange 318 may include a hole 318a through which an end of the bolt extends 310 to support and maintain the bolt in place. The portion of the bolt extending inwardly past the flange 318 may include a lever handle 312 which may be used to pull the bolt 310 out of the locking holes of the hinge assembly 300 to unlock the rotational plate 302 relative to the stationary plates 304, 306 or push the bolt into the locking holes to lock the rotational plate 302 relative to the stationary plates 304, 306. Like in hinge assembly 110, a bolt spring may be used to bias the bolt 310 back into the locking holes to lock the hinge assembly 300 when the lever handle 312 is released.

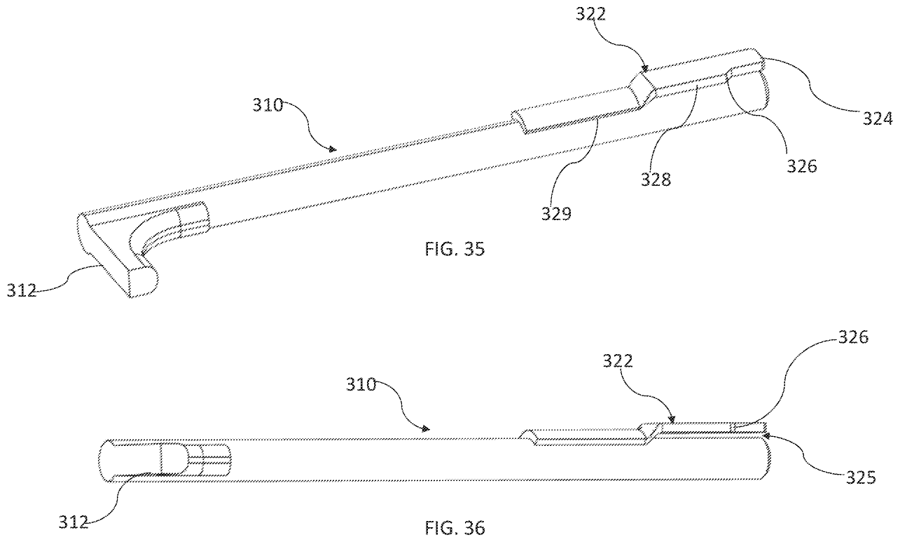

With reference to FIGS. 35 and 36, the bolt 310 includes a locking projection 322 that extends along an end of the bolt 310 opposite the lever handle 312. The locking projection 322 includes a wedge or cam surface 326 that increases tension between the rotational plate 302 and the fixed plates 304, 306 to reduce or eliminate slack therebetween. In one approach, the locking projection 324 includes a first narrow portion 324 that is sized to fit through the locking holes in all of the plates 302, 304, 306, a second wide portion 322 that does not fit through the locking holes, and a wedge or cam surface 326 between the first narrow portion 324 and the second wide portion 322 that has a width that gradually increases from the width of the first narrow portion 324 to the width of the second wide portion 322. In certain embodiments, the above-noted portions of the locking projection 322 may be spaced from the bolt 310 defining a small gap 325 therebetween. An attachment portion 329 of the locking projection extending from the second wide portion 322 may fix the locking projection 322 to the bolt 310. The small gap 325 may permit the locking projection 322 to have a degree of flexibility when it is inserted into the locking holes.

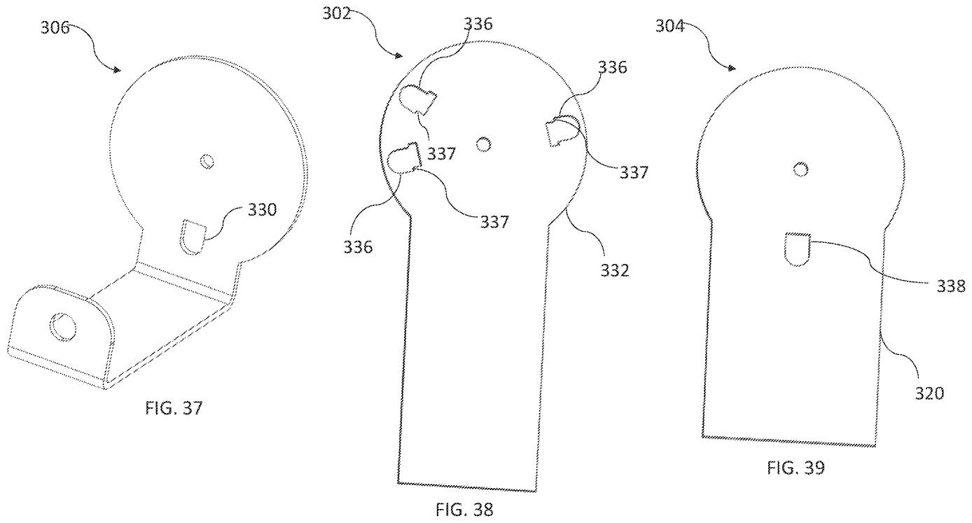

With reference to FIGS. 37-39, the first and second stationary plates 306, 304 each respectively include a locking pin hole 330, 338 shaped and sized to receive at least a portion of the bolt 310 and the locking projection 322. For instance, the locking pin holes 330, 338 may include a curved bottom corresponding to the shape of the bolt 310 and a linear top and sides corresponding to the profile of the locking projection 322.

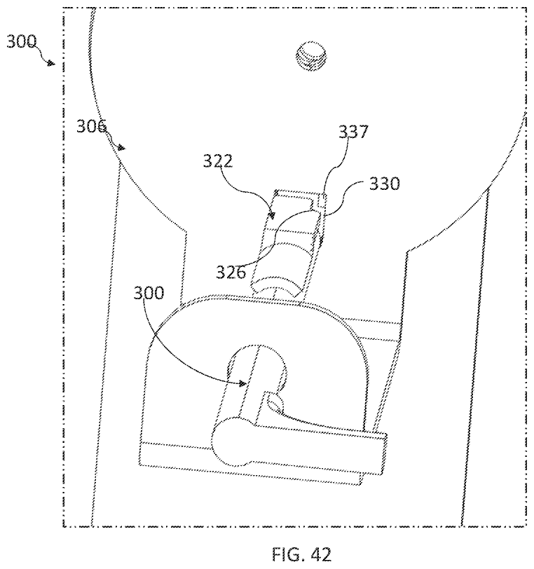

The rotational plate 302 may have a plurality of locking holes 336 corresponding to different positions of the ladder. For instance, there may be three locking holes 336 corresponding, for example, to a stepladder configuration, a folded or lean-safe ladder configuration, and an extended straight configuration. The locking holes 336 have a unique geometry configured to interact with the wedge 326 of the locking projection 322 to increase the tension between the plates and thereby reduce slack. For instance, each locking hole 336 may be sized and shaped similarly to the locking holes 330, 338 of the stationary plates, with a linear top portion and a curved bottom portion, but the linear top portion may instead be offset relative to the sides and curved bottom. Offsetting the linear top portion from the curved bottom portion in this manner defines a projection 337 that extends into the locking hole 336. When the leading end of the bolt 310 extends into the locking hole 336 to lock the rotational plate 302 (see FIG. 42), the wedge 326 engages the projection 337, creating a constant tension therebetween and forcing the rotational plate 302 to rotate slightly clockwise relative to the stationary plates 304, 306, thereby removing rotational slack between the plates.

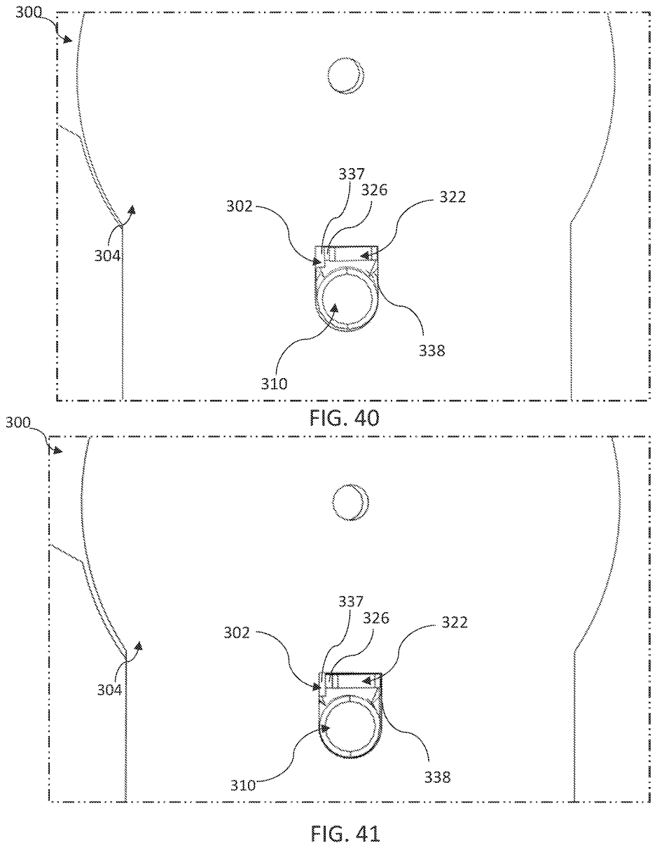

This interaction is best illustrated in FIGS. 40 and 41. FIGS. 40 and 41 illustrate the locking mechanism shown when looking through the locking hole 338 of the second stationary plate 304. Specifically, FIG. 40 illustrates an unlocked state of the hinge assembly 300 and FIG. 41 illustrates a locked state of the hinge assembly 300. In FIG. 40, the bolt 310 is engaging the locking holes of at least the first stationary plate 306 and the rotational plate 304, but the wedge 326 has not yet contacted the projection 337 in the locking hole 336 of the rotational plate 302. FIG. 41 illustrates the position of the plates after the wedge 326 has engaged the projection 337. As shown, the wedge 326 has forced the rotational plate 302 to move slightly clockwise relative to the stationary plates 304, 306 so that the bolt 310 holds the rotational plate 304 in tension relative to the stationary plates 304, 306.

While the hinge assembly 300 is not shown attached to a ladder, and the hinge assembly 300 as illustrated is different in several respects from hinge assembly 110, it will be appreciated that ladder 100 and hinge assembly 110 can be modified to include the bolt 310 and locking hole geometries described above to reduce slack in the hinges.

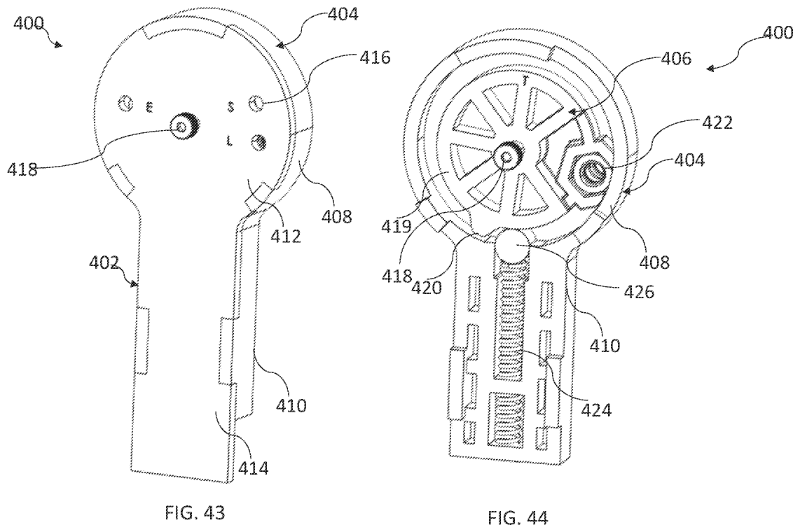

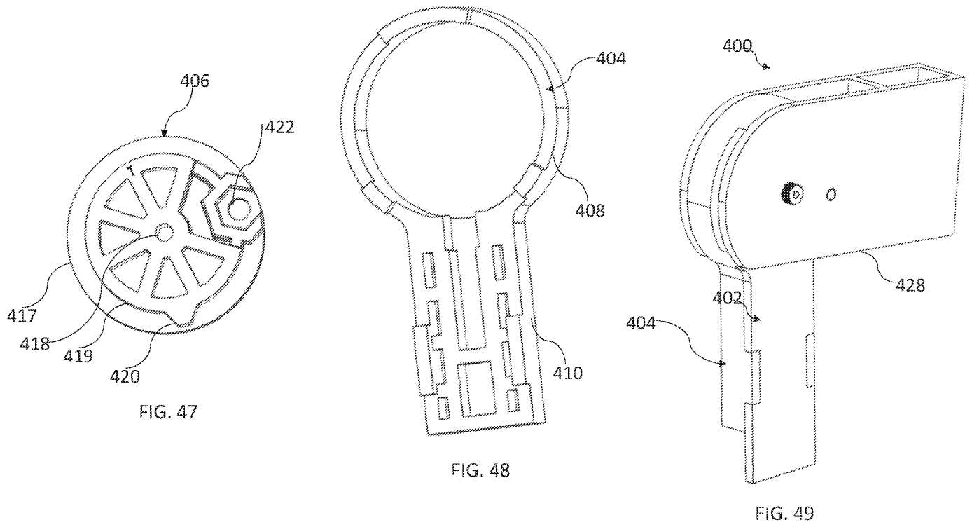

With reference to FIGS. 43-49, there is another hinge assembly 400 for a ladder that has reduced or eliminated slack. As shown, the hinge assembly 400 includes a first rotational component 402 which is a locking plate, a second rotational component 404 which is coupled to the first rotational component 402 and rotates therewith, and a stationary plate 406. In this embodiment, springs and rollers or bearings on the second rotational component 404 press against a cam 420 on the stationary plate 406 to bias the hinge assembly 400 to take up slack.

With reference to FIGS. 43-44 and 48, the second rotational component 404 includes an annular portion 408 and an elongate portion 410. The annular portion 408 couples to a round disc portion 412 of the first rotational component 402. The elongate portion 410 couples to an elongate portion 414 of the first rotational component 402. The elongate portion 410 of the second rotational component 404 and the elongate portion 414 of the first rotational component 402 can be coupled to a rear rail of the ladder (e.g., inserted therein). The stationary plate 406 is disposed within the annular portion 408 of the second rotational component 404 and may be directly or indirectly fixed to a front rail of the ladder, for example via a bracket. The first and second rotational components 402, 404 are rotatably connected to the stationary plate 406 via a pivot 418 extending through the stationary plate 406 and the first rotational component 402 at the disc portion 412.

The disc portion 412 of the first rotational component 402 includes a plurality of locking holes 416 corresponding to different positions of the ladder. The elongate portion 410 of the second rotational component 404 houses an elastomeric biasing member, such as a spring 424. The spring 424 is biased to force a roller 426 disposed at the interface between the elongate portion 410 and the annular portion 408 of the second rotational component 404 radially against a round projection 419 of the stationary plate 406.

With reference to FIGS. 44-47, in some embodiments the stationary plate 406 has a generally planar or flat round base 417 and a round projection 419 that projects axially from the base 417 towards the first rotational component 402. The round projection 419 may, as illustrated, be an annular wall. In other embodiments, the round projection 419 may be an annular disc. The round projection 419 may have a diameter that is only slightly less than the diameter of the base 417. The stationary plate 406 further includes a locking pin hole 422 for receiving a locking bolt (not shown), which may be disposed on the round projection 419, on the base 417, or somewhere therebetween. The cam 420 projects radially from the perimeter of the round projection 419.

When the hinge assembly 400 is unlocked and the first and second rotational components 402, 404 are free to rotate relative to the stationary plate 406, rotating the first and second rotational components 402, 404 rolls the roller 426 about the perimeter of the round projection 419. Because the roller 426 is round and, except for the cam 420, the projection 419 of the stationary plate 406 is round, as the rear rail of the ladder is rotated relative to the front rail, the second rotational component 404 attached to the rear rail moves with the rear rail, causing the roller to roll along the perimeter of the projection 419 of the stationary plate 406 without impediment. The roller 426 can be forced over the cam 420 to pass the cam 420 when the surface of the cam 420 forces the roller 426 further into the elongate portion 410 of the second rotational component 404 via the cam 420 pressing on the roller 426 to compress the spring 424. When the roller 426 has passed over the cam 420, the biasing of the spring 424 forces the roller 426 back against the perimeter of the projection 419.

In FIG. 44, the first and second rotational components 402, 404 are positioned so that the rear section of the ladder is somewhere between the extended straight and stepladder configurations and the hinge assembly 400 is unlocked. In an unlocked position, the roller 426 does not engage the cam 420.

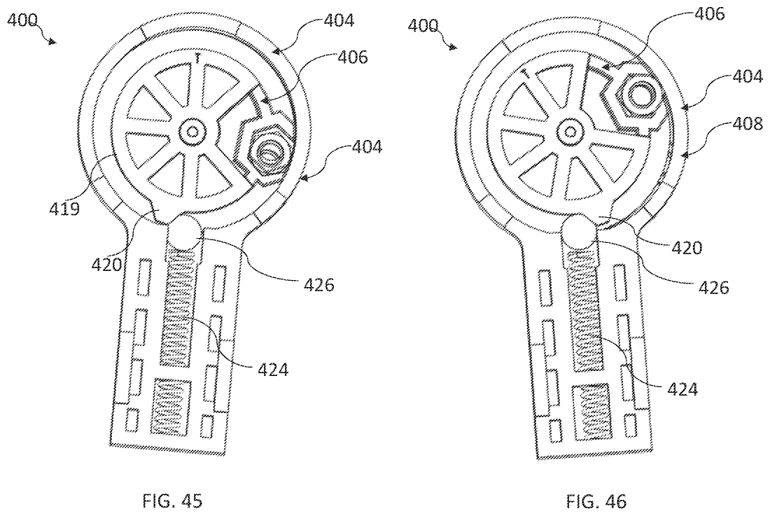

In FIG. 45, the hinge assembly 400 has been locked so that the ladder is in the stepladder configuration. That is, though not shown, the locking bolt has been locked into one of the locking holes 416 of the first rotational component 402 corresponding to the stepladder configuration. In this configuration, the roller 426 is pressed against a first side of the cam 420, which tends to rotate the rear section of the ladder slightly counterclockwise, reducing slack in the hinge assembly 400.

In FIG. 46, the hinge assembly 400 has been locked so that the ladder is in the folded or leaning configuration. In this configuration, the roller 426 is pressed against a second side of the cam 420, which tends to rotate the rear section of the ladder slightly clockwise, reducing slack in the hinge assembly 400.

In embodiments, the roller 426 pressed against the cam 420 in the above-described locking positions causes the locking hole 416 of the first rotational component 402 to be slightly shifted to press against the locking bolt to provide tension between the stationary plate 406 and the first rotational component 404, reducing slack in the hinge assembly 400.

FIG. 49 illustrates a U-shaped bracket 428 which may be used to fix the stationary plate 406 to the front rail. However, other brackets or methods of fixing the stationary plate 406 to the front ladder section are also contemplated.

In addition, it will be appreciated that the slack removing mechanism described for hinge assembly 400 can also be included in a modified version of ladder 100 and hinge assembly 110 described above.

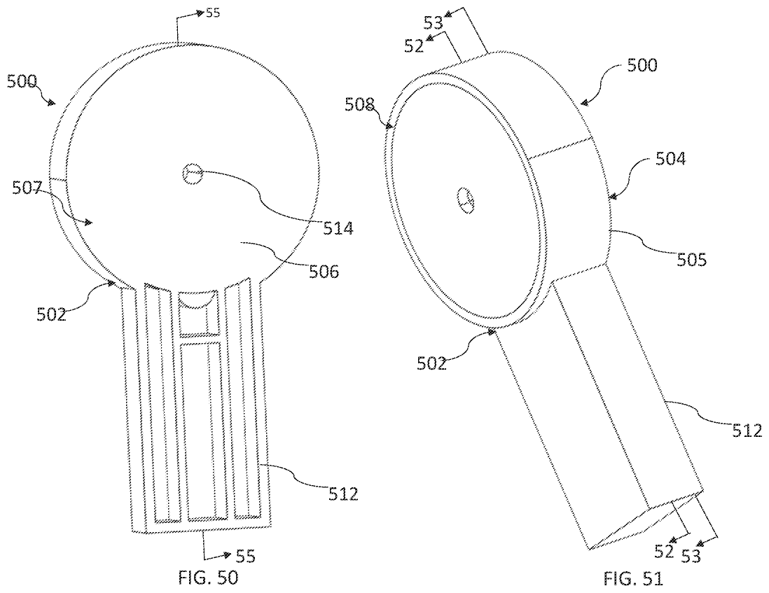

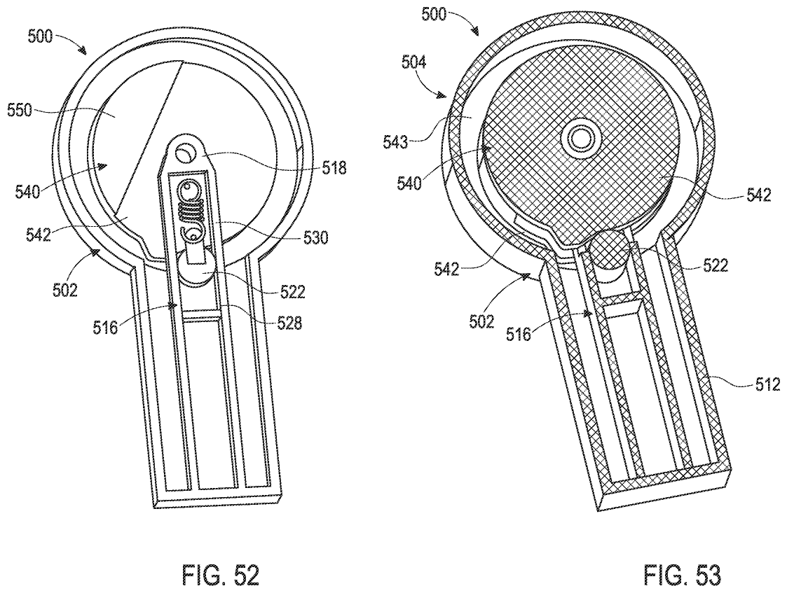

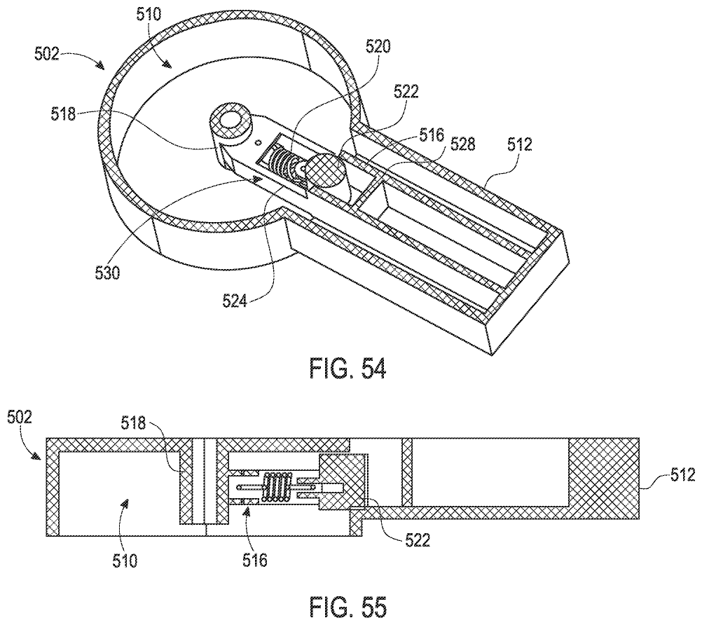

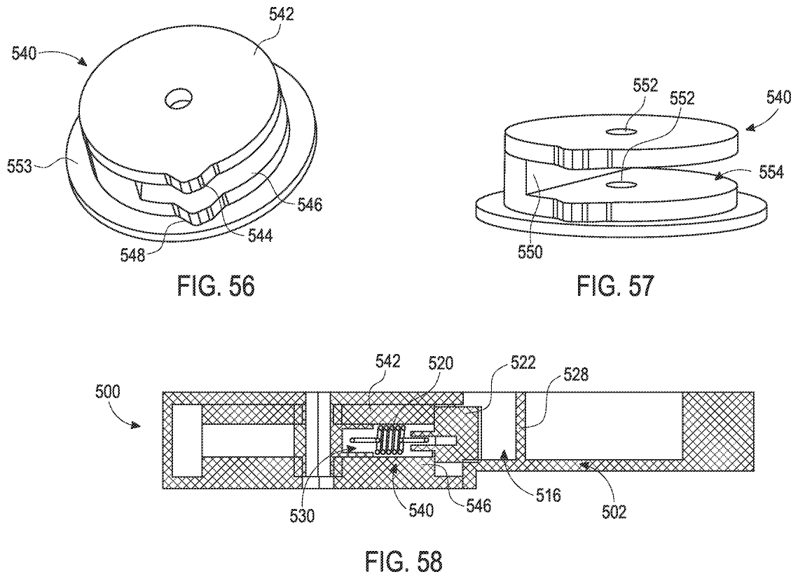

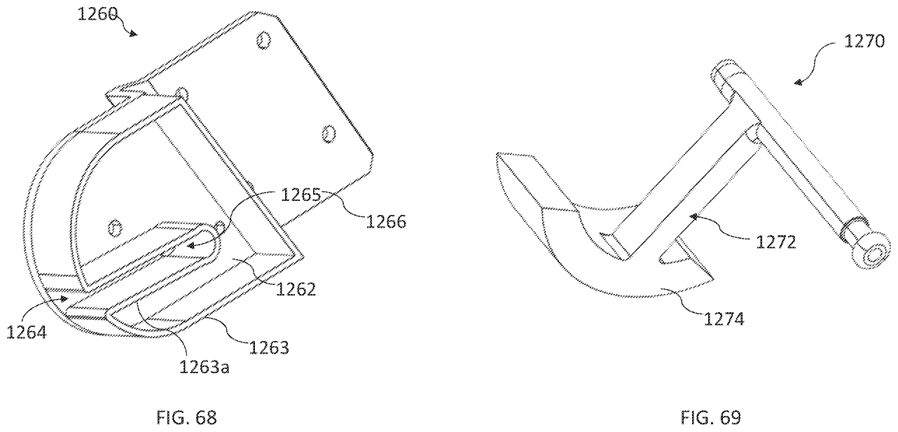

With reference to FIGS. 50-68, there is shown another hinge assembly 500 for a ladder that has reduced or eliminated slack. The hinge assembly 500 has a similar mechanism to that of hinge assembly 400, though uses a tension spring with a roller extending from a central portion of the hinge and a split stationary plate having split cams, as explained further below.

The hinge assembly 500 includes a rotational component 502 having a round hinge portion 504 and an elongate rail attachment/insert portion 512 which is fixed to a rear rail of the ladder so that it rotates therewith. The round hinge portion 504 includes an annular side wall 505 and has a first closed side 507 defined by a cover wall 506 and a second open end side 508. A round inner compartment 510 is defined within the round hinge portion 504 by the annular side wall 505 and the cover wall 506. A pivot 514 rotatably couples the rotational component 502 to a split stationary plate 540, which is positioned within the inner compartment 510. Though not shown, the split stationary plate 540 is attached directly or indirectly to the front ladder section and thus fixed relative thereto. It is noted that the locking holes of the rotational component 502 for locking the ladder into different positions are also not illustrated, though would be understood to be present in the rotational component 502 or in an additional rotational plate coupled thereto.

An elongate channel 516 extends within at least a portion of the elongate portion 512 and within the round hinge portion 504. A first portion 528 of the elongate channel is in the elongate portion 512 while a second portion 530 is in the round hinge portion 504. In some approaches, the elongate channel 516 extends radially from an axial pivot channel 518 (illustrated best in FIG. 55) that extends into the compartment 510 from the pivot point 514. The elongate channel 516 may be attached to the pivot channel 518 or formed integrally therewith.

The elongate channel 516 houses a roller 522 and a tension spring 520. The tension spring 520 is positioned in the second portion 530 of the elongate channel 516 within the round hinge portion 504 while the roller 522 is disposed between the first portion 528 and the second portion 530, halfway between the elongate portion 512 and the round hinge portion 504. The roller 522 may be held by a yoke, not shown, which allows the roller 522 to roll against the split stationary plate 540 when the rear rail is moved. The tension spring 520 may be attached directly to the yoke.

The stationary plate 540, as noted above, has a split configuration with a round first plate 542 and a round second plate 546 that are identical to one another. The first plate 542 is aligned above the second plate 546 and spaced therefrom, defining a gap 554 between the plates 542, 546. An attachment portion 550 between the first plate 542 and the second plate 546 attaches the plates 542, 546 together and holds them spaced apart. In some approaches, the second plate 546 is seated flush against a third base plate 453 which may be sized with a wider diameter to close up the second open end 508 of the rotational component 502 when inserted therein. All three of the plates may have pivot openings 552 for the pivot. In one approach, the pivot openings 552 of the first plate 542 and the second plate 546 allow the pivot channel 518 of the rotational component 502 to extend therethrough. The three plates are also assumed to each have a locking pin hole for the locking bolt to extend through, which is not shown.

The first and second plates 542, 546 include a first cam 544 and a second cam 448, respectively, projecting from the respective perimeters of the first and second plates 542, 546 for being engaged by the roller 522 to reduce slack in the hinge locks when the ladder is locked into the desired position.

The roller 522 is seated in part in the first portion 528 of the channel 516 located in the elongate portion 512 of the rotational component 502. As noted above, part of the roller 522 extends into the second portion 530 of the channel 516, within the cavity 510 of the round hinge portion 504. The second portion 530 of the channel 516 does not have a bottom to support the roller 522 at the location where the roller 522 extends into the second portion 530. Thus, the bottom of the roller 522 is exposed to the perimeter of the second stationary plate 546 so that it can roll along the perimeter. The top of the roller 522, on the other hand, is exposed to the perimeter of the first stationary plate 542 so that it can roll along the perimeter. Specifically, the top and bottom of the roller 522 extend axially above and below recessed side walls 524 of the second portion 530 of the channel 516 so that the top and bottom of the roller 522 can engage the two perimeters of the two stationary plates 542, 546 as the rotational component 502 is rotated. This arrangement is shown most clearly in FIG. 58.

When the rotational component 502 is rotated relative to the stationary plates 542, 546, the roller 522 is able to be forced past the cams 544, 548 by the cam surfaces of the cams 544, 548 pushing the roller 522 further into the second portion 528 of the channel 516 so there is less contact between the cams 544, 548 and the roller 522. Thus, the roller 522 can more easily pass the cams 544, 548. When this occurs, the tension spring 520 is stretched. When the roller 522 has passed over the cams 544, 548, the bias of the spring 520 draws the roller 522 back into the initial position in which it engages the perimeters of the stationary plates 542, 546.

Similar to hinge assembly 400, when hinge assembly 500 is locked into one of the hinge locking holes (not shown) of the rotational component 502 corresponding to the stepladder configuration or the lean-safe configuration, the roller 522 is forced against the two cams 544, 548 by the biasing of the spring 520 to take up slack in the hinge locking hole. In the stepladder configuration the roller 522 is positioned pressed against one side or surface of the cams 544, 548 while in the lean-safe configuration the roller 522 is positioned pressed against the other side or surface of the cam members 544, 548. The force of the roller 522 against the cams 544, 548 slightly moves the rotational component 502 so that a side of the hinge locking hole is held in tension against the locking bolt, which reduces the slack in the hinge.

It is contemplated that this slack removing mechanism described for hinge assembly 500 can also be included in a modified version of ladder 100 and hinge assembly 110 described above. For instance, the stationary plate 540 may have a bracket extending therefrom that attaches it to a front rail of the ladder, and a cover plate such as cover plate 136 may be present coupled to the stationary plate 540 to support a lock assembly such as the sliding lock assembly 116.

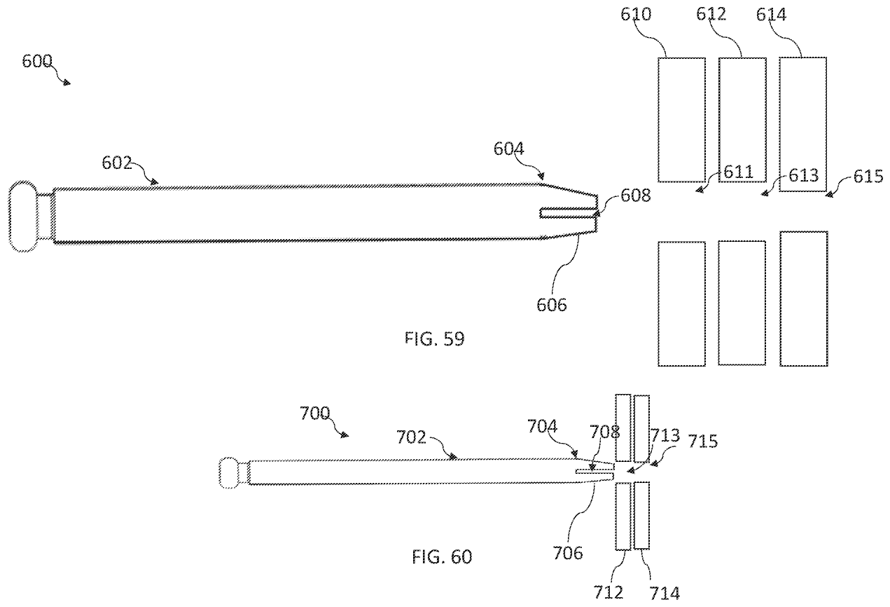

With reference to FIGS. 59-65, there are shown additional embodiments of hinge assemblies for a ladder having reduced or eliminated slack. In these examples the locking bolt which extends into the hinge to lock the hinge in a desired position of the ladder has a specific geometry to increase tension in the locking holes. While the below examples illustrate the rotational plate as the outermost or external plate and the one or more stationary plates positioned inwardly in the hinge from the rotational plate, it is also contemplated that the position of the rotational and stationary plates described below can be reversed, with the stationary plate as the outermost or external plate.

FIG. 59 illustrates a diagrammatic or simplified cross-sectional view of a hinge assembly 600 for a ladder that has reduced or eliminated slack. In this example, a locking bolt 602 (which may be spring-biased and used with a locking assembly such as sliding lock assembly 116) has a leading end or head having a plurality of flexible teeth 606. For instance, there may be two or more flexible teeth with a gap 608 therebetween. In one non-limiting example, there may be four flexible teeth. The flexible teeth 505 may angle radially inwards to form a conical tip 604 of the locking bolt 602. The locking holes 615 of the rotational plate 614 may have a diameter that is smaller than a diameter of at least a portion of the conical tip 604 so that when the locking bolt 602 extends into the hinge, the locking hole 615 squeezes the teeth 505 together as the angled surface of the conical tip 604 moves through the hole. Once in place in the locking hole 515, the teeth 505 may put pressure on the surface of the locking hole 615 in an attempt to return to their uncompressed position. In addition, the remainder of the bolt 602 may have a diameter corresponding precisely to the diameter of the locking pin holes of any stationary plates disposed in front of the rotational plate 614 (e.g., a locking pin hole 611 of a cover plate 610 or a locking pin hole 613 of an inner stationary plate 612), which have a wider diameter than the diameter of the locking holes 615 of the rotational plate 614. Thus, there is a constant and continuous force of the bolt 602 against all of the locking holes of the plates which maintains tension between the rotational plate 614 and the stationary plates and eliminates slack therebetween.

FIG. 60 illustrates a diagrammatic or simplified cross-sectional view of another hinge assembly 700 for a ladder that has reduced or eliminated slack. This example is the same as hinge assembly 600, except the conical tip 704 of the bolt 702 containing the flexible teeth 706 presses against both the locking hole 715 of the rotational plate 714 and the locking pin hole (e.g., 713) of one or more stationary plates (e.g., 712) ahead of the rotational plate 714. In such an example, the diameter of the locking hole 715 of the rotational plate 714 may be slightly smaller than the diameter of the locking pin hole 713 of the stationary plate 712 to compress a narrower portion of the conical tip 704. The diameters of both the locking hole 715 of the rotational plate 714 and the locking pin hole 713 of the stationary plate 712 may be sized to slightly squeeze portions of the conical tip 704 of the bolt 702, thus creating a constant and continuous force of the bolt 702 against the holes which maintains tension between the rotational plate 714 and the stationary plate 712 and eliminates slack therebetween.

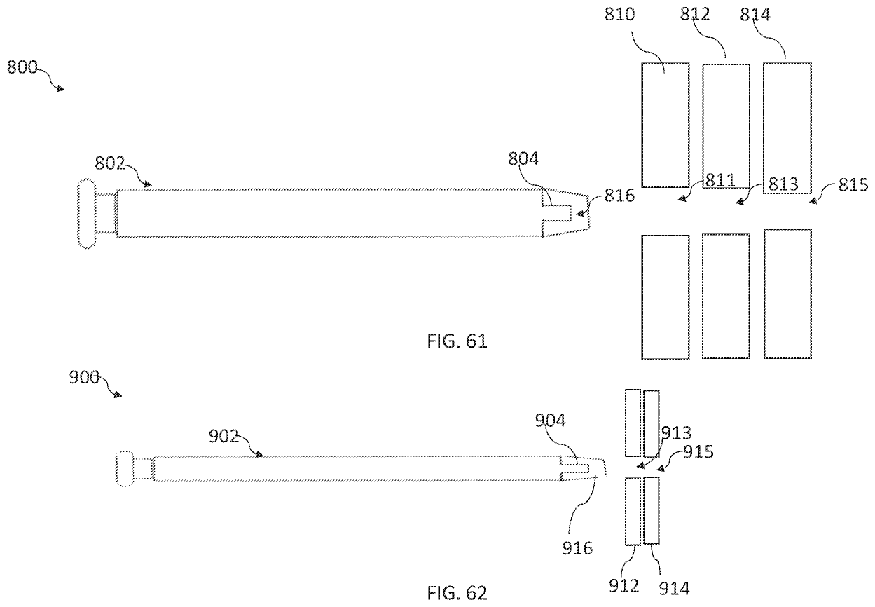

FIG. 61 illustrates a diagrammatic or simplified cross-sectional view of another hinge assembly 800 for a ladder that has reduced or eliminated slack. This example has a similar principle to hinge assemblies 600 and 700, however, instead of flexible teeth, an elastomeric tip is used for the bolt (which may be spring-biased and used with a locking assembly such as sliding lock assembly 116).

Specifically, the bolt 802 may have a terminal projection 804 that is fitted with an elastomeric tip 816. For instance, rubber may be used. The elastomeric tip 816 may be conical. When the bolt 802 extends into the locking hole 815 defined in the rotational plate 814, the locking hole 815, having a diameter that is smaller than a portion of the elastomeric tip 816, compresses the elastomeric tip to fit into the locking hole 815. Once in place in the locking hole 815, the elastomeric tip 816 exerts pressure on the surface of the locking bole 815 in an attempt to return to its uncompressed position. In addition, the remainder of the bolt 802 may have a diameter corresponding precisely to the diameter of the locking pin holes of any stationary plates disposed in front of the rotational plate 814 (e.g., a locking pin hole 811 of a cover plate 810 or a locking pin hole 813 of an inner stationary plate 812), which have a wider diameter than the diameter of the locking holes 815 of the rotational plate 814. Thus, there is a constant and continuous force of the bolt 802 against all of the locking holes of the plates which maintains tension between the rotational plate 814 and the stationary plates and eliminates slack therebetween.

FIG. 62 illustrates a diagrammatic or simplified cross-sectional view of another hinge assembly 900 for a ladder that has reduced or eliminated slack. This example is the same as hinge assembly 800, except the elastomeric tip 916 of the bolt 902 is compressed by both the locking hole 915 of the rotational plate 914 and the locking pin hole (e.g., 913) of one or more stationary plates (e.g., 912) ahead of the rotational plate 914. In such an example, the diameter of the locking hole 915 of the rotational plate 914 may be slightly smaller than the diameter of the locking pin hole 913 of the stationary plate 912 to compress a narrower portion of the elastomeric tip 916. The diameters of both the locking hole 915 of the rotational plate 914 and the locking pin hole 913 of the stationary plate 912 may be sized to slightly squeeze portions of the elastomeric tip 816 of the bolt 902, thus creating a constant and continuous force of the bolt 902 against the holes which maintains tension between the rotational plate 914 and the stationary plate 912 and eliminates slack therebetween.

It is contemplated that spring steel may also be used instead of rubber for the elastomeric tip in hinge assemblies 800 and 900 and have a similar effect.

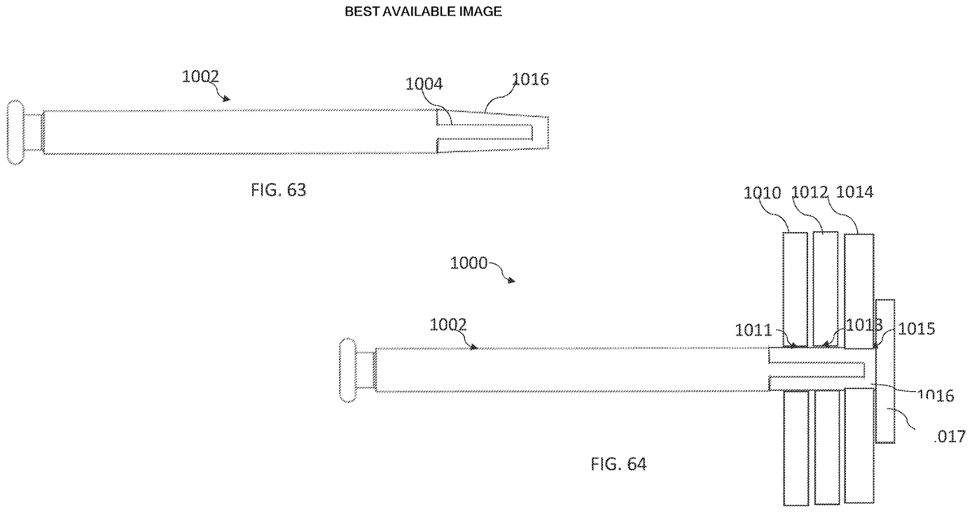

FIG. 63 illustrates a cross-sectional view of another locking bolt 1002 that can be used in the hinge assembly 1000 shown in FIG. 64. The locking bolt 1002 is similar to locking bolt 902 with an elastomeric tip 1016 that may have a conical shape. The elastomeric tip 1016 may have an elongated tapered surface to extend through the rotational plate 1014 and one or more stationary plates 1010, 1012 when the bolt is in the locked position. In this example, however, there is a further plate 1017 disposed on an external side of the rotational plate 1014 against the locking hole 1015 of the rotational plate 1014. When the bolt is locked in the locking hole 1015, the elastomeric tip 1016 may smash into the plate 1017, causing expansion of the elastomeric tip 1016 against the inner surface of the locking hole 1015. The smashing may also cause expansion of the elastomeric tip 1016 against the inner surfaces of one or more locking pin holes 1011, 1013 in the one or more stationary plates 1010, 1012. The force of the expanded elastomeric tip 1016 against the hinge holes maintains a tension between the rotational plate 1014 and the one or more stationary plates 1010, 1012, removing slack therebetween.

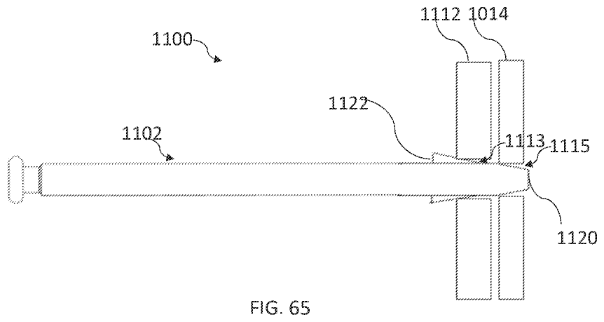

FIG. 65 illustrates a diagrammatic or simplified cross-sectional view of another hinge assembly 1100 for a ladder that has reduced or eliminated slack. This example employs a two-stage bolt 1102 that has two different stages 1120, 1122 each configured to create respective tension against an outer locking hole 1115 of an outer plate 1114 (e.g., a rotational plate) and an inner locking hole 1113 of at least one inner plate 1112 (e.g., a stationary plate). The outer locking hole 1115 of the outer plate 1014 is engaged by a first angled or conical tip of the bolt 1102 defining the first stage 1120. The portion of the angled tip 1120 having a diameter larger than the diameter of the outer locking hole 1115 is compressed by the outer locking hole 1115, creating tension therewith. The inner locking hole 1113 of the inner plate may have a diameter sized larger than the largest diameter of the angled tip 1120 to allow the angled tip 1120 to pass unimpeded therethrough. The diameter of the inner locking hole 1113, however, has a diameter sized to compress at least a portion of the second stage 1122 of the bolt 1102. By one approach, the second stage 1122 of the bolt also has a conical shape. For instance, the second stage 1122 may be defined by an angled annular flange. At a certain point when the second stage 1122 moves into the inner locking hole 1113 of the inner plate, the diameter of the second stage 1122 is larger than the diameter of the inner locking hole 113, and the second stage 1122 is thus compressed by the inner locking hole 1113, creating tension therewith. The tension that is created between the first stage 1120 of the bolt 1102 with the outer locking hole 1115 and the second stage 1122 of the bolt 1102 with the inner locking hole 1113 reduces slack between the inner plate 1112 and the outer plate 1114.

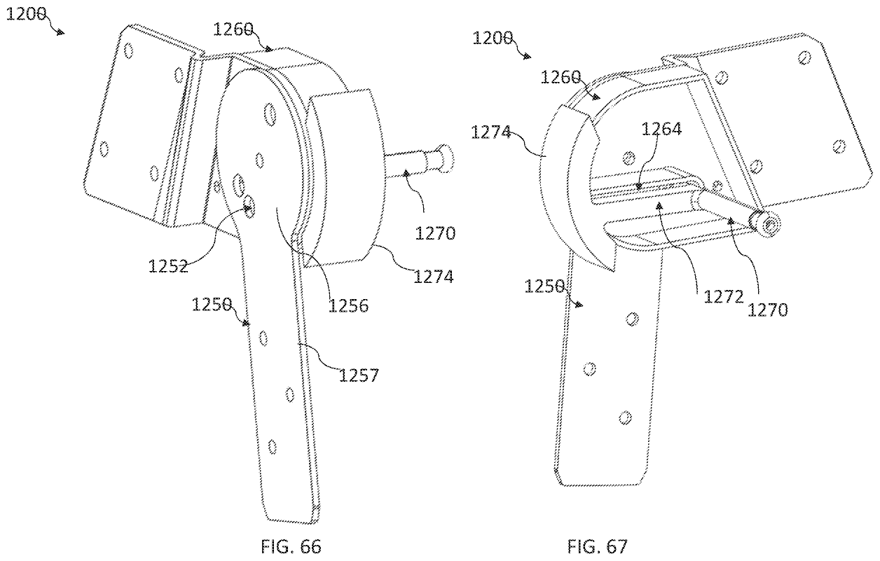

With reference to FIGS. 66-71, there is shown another hinge assembly 1200 for a ladder that has reduced or eliminated slack. The hinge assembly 1200 includes a rotational plate 1250 having a disc portion 1256 pivotably coupled to a stationary plate 1260. The rotational plate 1250 further includes an elongate rail attachment portion 1257 for attachment to a rear rail of the ladder. The rotating plate includes a plurality of locking holes 1252 for receiving a locking bolt 1270 to lock the ladder in a desired position.

The stationary plate 1260 includes a disc portion 1262 having a locking pin hole 1265 for receiving the locking bolt 1270. The stationary plate 1260 is fixed to a front rail of the ladder (e.g., via bracket 1266). A wall 1263 projects from the disc portion 1262 in a direction away from the rotational plate 1250. The wall 1263 may project from an entire perimeter of the disc portion 1262 to define a housing except at a portion of the perimeter of the disc portion 1262 where the wall 1263 instead extends inwardly from the perimeter towards the locking pin hole 1265. This inward portion 1263a of the wall 1263 loops around the locking pin hole 1265 and defines a slot 1264 that extends from the locking pin hole 1265 to the perimeter of the disc portion 1262. The slot 1264 is open at the perimeter of the disc portion 1262.

The locking bolt 1270 includes a radial stem 1272 extending radially from the bolt 1270. The radial stem 1272 extends perpendicularly adjacent a leading end portion of the bolt 1270 (i.e., the end that first engages the hinge), though not disposed on the end itself. At a distal end of the radial stem 1272 is an arcuate block 1274. While the radial stem 1272 of the bolt 1270 is configured to move in and out of the slot 1264 of the stationary plate 1260 during locking and unlocking of the hinge, the arcuate block 1274 is positioned radially outward from the slot 1264, and radially outward from the stationary plate 1260. Specifically, the arcuate block 1274 has a curvature that corresponds to a curvature of the wall 1263 at the perimeter of the stationary plate 1260 and is configured to wrap around and slide against the wall 1263 during locking and unlocking of the hinge.

When the hinge assembly 1200 is locked into a desired position of the ladder, the arcuate block 1274 creates tension with the rotational plate 1250 to reduce rotational slack. FIG. 67 illustrates the hinge assembly 1200 in an unlocked state. The bolt 1270 is drawn out of the locking hole 1252 of the rotational plate 1250, which draws the radial stem 1272 out of the slot 1264 and the arcuate block 1274 away from the rotational plate 1250, freeing the rotational plate 1250 to rotate.

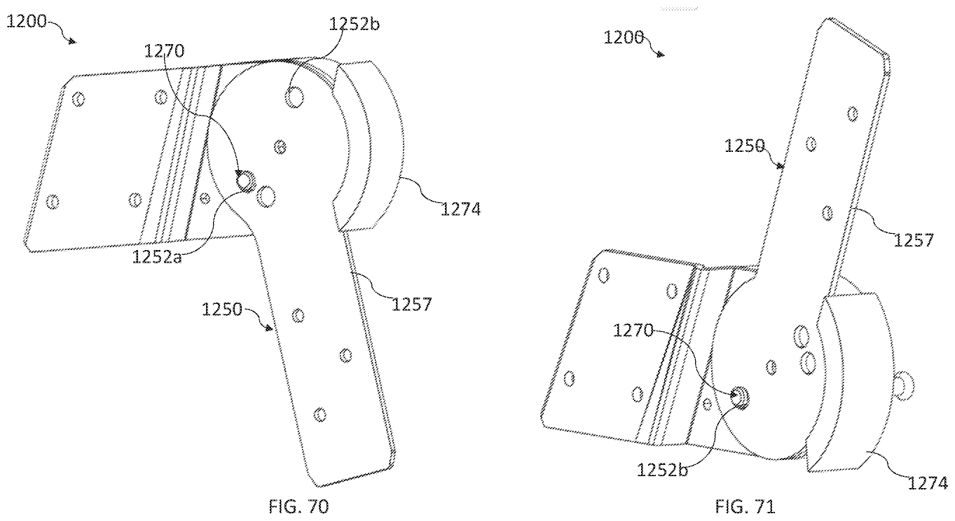

FIG. 70 illustrates the hinge assembly 1200 in a locked state in the stepladder configuration. In this state, the bolt 1270 is drawn into locking hole 1252a of the rotational plate 1250, which draws the radial stem 1272 into the slot 1264 and the arcuate block 1274 towards the rotational plate 1250 so that a portion of the arcuate block 1274 protrudes past the rotational plate 1250. The bottom end of the arcuate block 1274 engages and presses against the elongate portion 1257 of the rotational plate 1250, creating tension against the rear rail in the stepladder configuration. This provides a tension between the stationary plate 1260 and the rotational plate 1250, removing slack between them.

FIG. 71 illustrates the hinge assembly 1200 in a locked state in the extended straight configuration. In this state, the bolt 1270 is drawn into locking hole 1252b of the rotational plate 1250, which draws the radial stem 1272 into the slot 1264 and the arcuate block 1274 towards the rotational plate 1250 so that a portion of the arcuate block 1274 protrudes past the rotational plate 1250. The top end of the arcuate block 1274 engages and presses against the elongate portion 1257 of the rotational plate 1250, creating tension against the rear rail in the extended straight configuration. This provides a tension between the stationary plate 1260 and the rotational plate 1250, removing slack between them.

It is contemplated that this slack removing mechanism described for hinge assembly 1200 can also be included in a modified version of ladder 100 and hinge assembly 110 described above. For instance, a cover plate such as cover plate 136 may be present coupled to the stationary plate 1260 to support a lock assembly such as the sliding lock assembly 116. It is also contemplated that the wall 1263 and the slot 1264 may be part of the cover plate 136 instead of the stationary plate 1260, or may be an insert at the interface between an inner stationary plate and a cover plate.

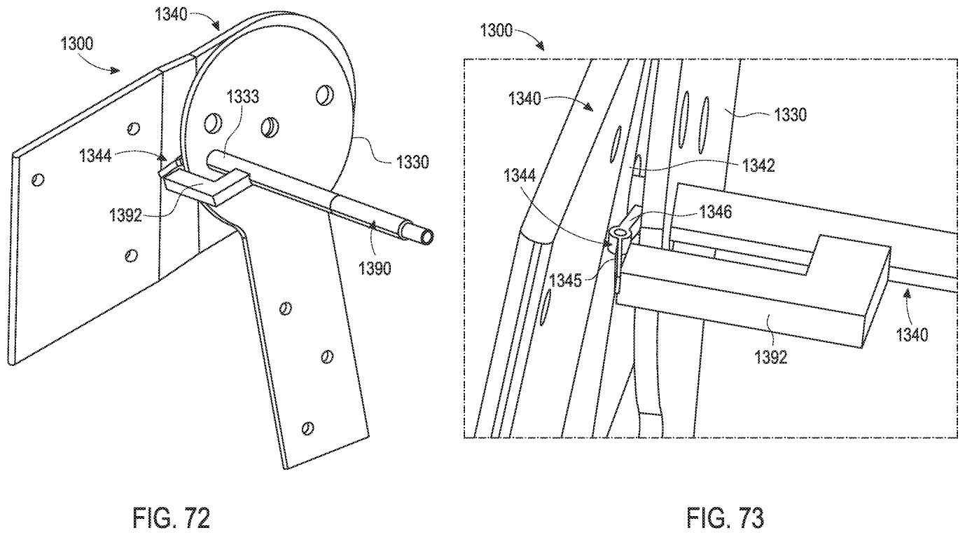

With reference to FIGS. 72-73, there is shown another hinge assembly 1300 for a ladder that has reduced or eliminated slack. The hinge assembly 1300 includes a rotational plate 1330 connected to a rear rail of the ladder and rotatably coupled to a stationary plate 1340 that is fixed to a front rail of the ladder. The rotational plate 1330 includes a plurality of locking holes 1333 to receive a locking bolt 1390 to lock the ladder in different positions.

The locking bolt 1390 includes an L-shaped projection 1392 that extends radially from the bolt 1390 adjacent a leading end portion of the bolt 1390. The L-shaped projection 1392 is positioned on the bolt 1390 so that when the bolt 1390 extends through a locking hole 1333 of the rotational plate 1330 and a locking pin hole 1342 of the stationary plate 1340, a terminal end of the L-shaped projection 1392 presses into a seesaw lever 1344 fixed to the stationary plate 1340 at a central pivot point of the seesaw lever. The seesaw lever has a first arm 1345 and a second arm 1346 that pivot relative to one another. Specifically, during locking, the first arm 1345 is contacted and pressed by the L-shaped projection 1392 towards the stationary plate 1340. When the first arm 1345 is pressed in this manner, the second arm 1346 swings in the opposite direction to press against the rotational plate 1330. In embodiments, the pressure exerted by second arm 1346 against the rotational plate 1330 angles the rotational plate 1330 away from the stationary plate 1340, as shown best in FIG. 73. This angling of the rotational plate 1330 causes a side of the locking hole 1333 to squeeze against the bolt 1390 extending therethrough. The tension created between the rotational plate 1330 and the stationary plate 1340 via the seesaw lever 1344 removes slack between the plates.

It is contemplated that this slack removing mechanism described for hinge assembly 1300 can also be included in a modified version of ladder 100 and hinge assembly 110 described above. For example, the bolt 1390 may be part of a lock assembly such as the sliding lock assembly 116.

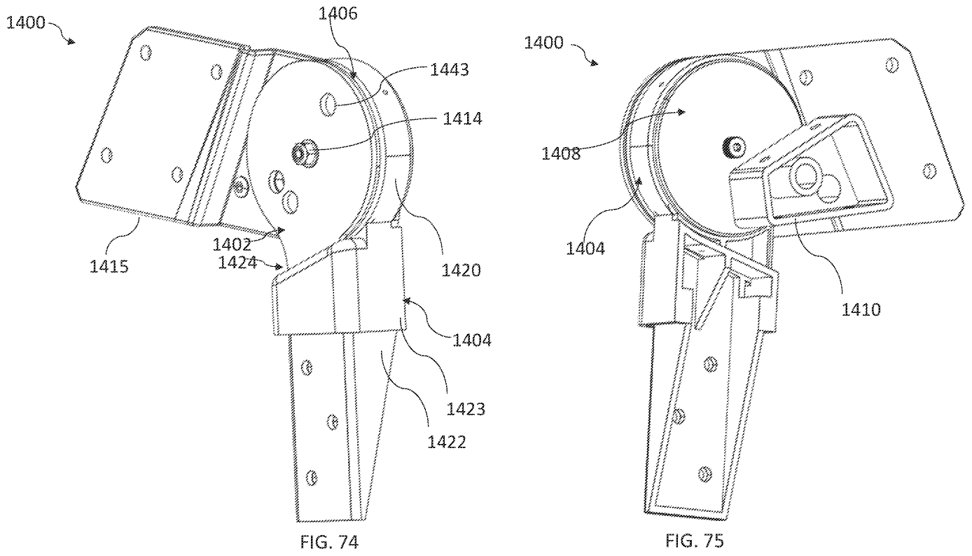

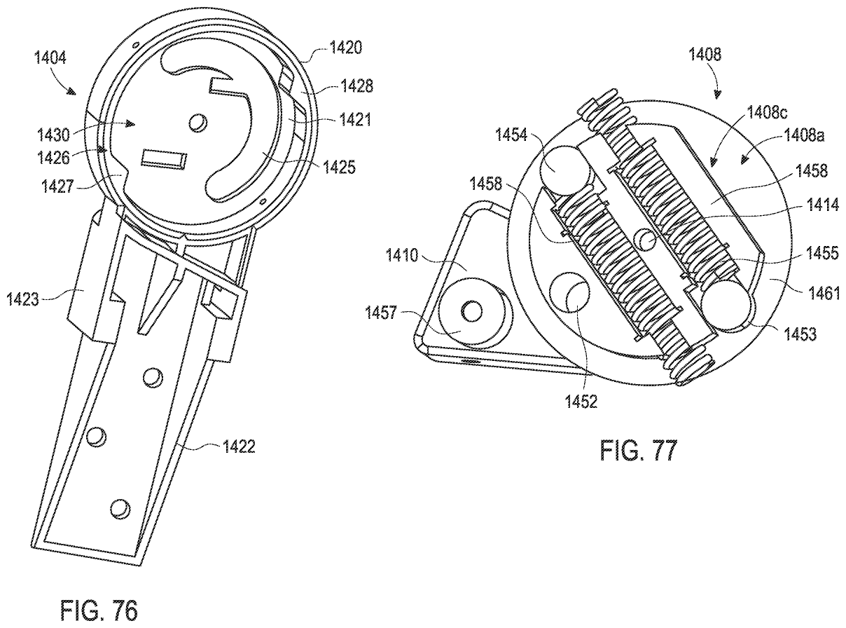

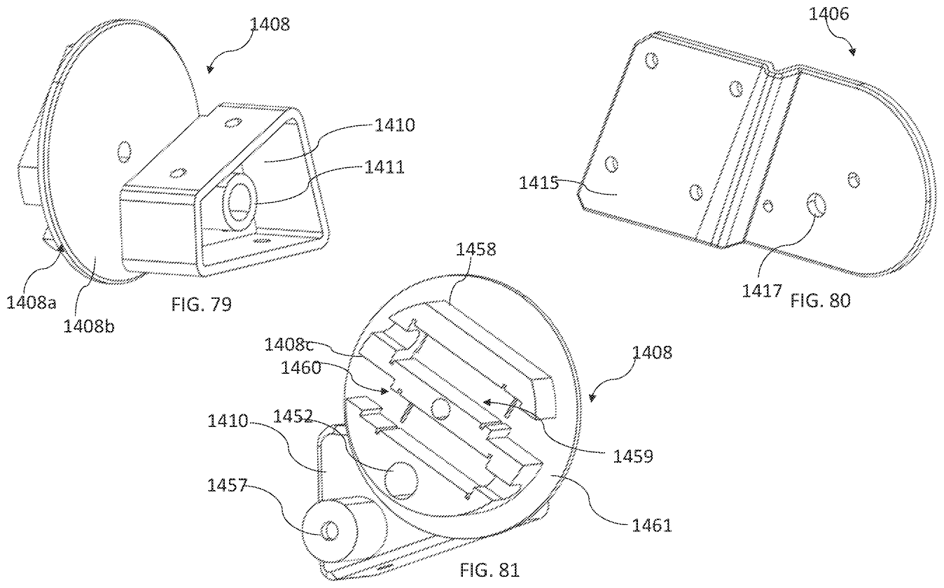

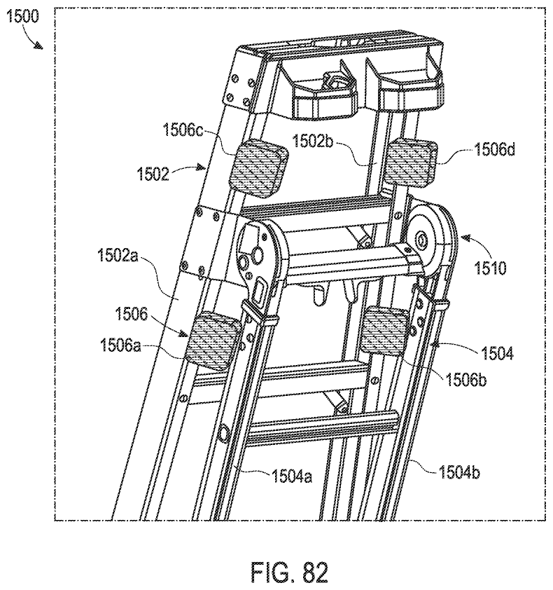

With reference to FIGS. 74-81, there is shown another hinge assembly 1400 for a ladder that has reduced or eliminated slack. Like hinge assemblies 400 and 500, hinge assembly 1400 uses spring-biased rollers engaging cam surfaces to reduce slack in the hinge, as described below.

The hinge assembly 1400 includes a first rotational component 1402, a second rotational component 1404, an inner stationary plate 1406, and a cover plate 1408. The first rotational component 1402 is similar to the rotational plate 130 of hinge assembly 110 and has a disc portion 1440 rotatably coupled to the rest of the hinge via a central pivot 1414 and an elongate portion 1442 coupled to a rear rail of the ladder. The disc portion 1440 also has a plurality of locking holes 1443 for locking the ladder in a plurality of different positions. Like in hinge assembly 110, the first rotational component 1402 is an outermost plate of the hinge assembly 1400.

A stationary plate 1406 is positioned adjacent the first rotational component 1402 and is similar to the stationary plate 132 described above for hinge assembly 110. A bracket 1415 extends from the stationary plate 1406 to fix the stationary plate 1406 to a front rail of the ladder. The stationary plate 1406 includes a locking pin hole 1417 for a locking bolt to extend through as it passes towards the locking holes 1443 in the first rotational component 1402.

The second rotational component 1404 includes a generally planar flat disc portion 1421 positioned in the hinge between the stationary plate 1406 and the cover plate 1408. An annular side wall 1420 projects from the perimeter of the flat disc portion 1421 towards the cover plate 1408, defining a cavity 1430 between the flat disc portion 1421 and the cover plate 1408. The annular side wall 1420 may abut the cover plate 1408. The second rotational component 1404 further includes an elongate portion 1422 extending from the flat disc portion 1421 that is coupled to or inserted in a rear rail of the ladder. Similar to the rotational support arm 139 in hinge assembly 110, the second rotational component 1404 includes a flange portion 1423 between the flat disc portion 1421 and the elongate portion 1422 that in part defines a slot 1424 for receiving the elongate portion 1442 of the first rotational component 1402. The first rotational component 1402, the second rotational component 1404, and the rear rail of the ladder are coupled together so that these components rotate together relative to the rest of the hinge assembly 1400.

The flat disc portion 1421 of the second rotational component 1404 includes an arcuate opening 1425. The locking bolt extends through the arcuate opening 1425, and, in some approaches, never leaves the arcuate opening 1425 even when the hinge assembly 1400 is unlocked. The arcuate opening 1425 is radially positioned and is sufficiently sized so that the second rotational component 1404 can have a sufficient range of rotational motion even when the locking bolt extends through the second rotational component 1404 and the stationary plate 1406.

The second rotational component 1404 further includes a cam ring 1427 which may be an insert fitted and coupled to the interior surface of the annular side wall 1420 or, in other approaches, may be formed integrally with the annular side wall 1420. The cam ring 1427 includes two opposing cam members 1427, 1428, each having two surfaces. The cam ring 1427 and cam members 1427, 1428 rotate with the second rotational component 1404 and are configured to engage rollers 1454, 1453 disposed in the cover plate 1408, described further below.

The cover plate 1408 is similar in some respects to the cover plate 136 of hinge assembly 110. The cover plate 1408 has a main planar or flat disc portion 1408a and a first side 1408b facing outside the hinge and a second side 1408c facing inside the hinge. The cover plate 1408, in some approaches, is molded and formed from a plastic such as polypropylene. A support channel 1410, similar to the support channel 161 in hinge assembly 110 projects from the first side 1408b of the cover plate 136 about the locking pin hole 1452 to support a lock assembly (such as the sliding lock assembly 116 described above). The support channel 1410 may have a portion that is offset from and extends off of the main disc portion 1408a and that includes an attachment member 1457 to fix the cover plate 1408 to the bracket 1415 of the stationary plate 1406. Thus, being fixed to the stationary plate 1406, the cover plate 1408 is fixed relative to the front section of the ladder.

As illustrated, in one approach a hollow shaft 1411 dimensioned to receive the locking bolt extends from the first side 1408b of the cover plate 1408 within the support channel 1410. The hollow shaft 1411 is continuous with the locking pin hole 1452 of the cover plate 1408 and provides further support to the locking bolt.

The second side 1408c of the cover plate 1408 retains two spring-biased rollers to engage the cam members 1427, 1428. In one approach, one or more projections 1468 from the disc portion 1408a define a first channel 1459 and a second channel 1460. The first channel 1459 retains a first spring 1455 that biases a first roller 1453 and the second channel 1460 retains a second spring 1456 that biases a second roller 1454. An annular space 1461 may be present around the one or more projections 1468 sufficiently sized for the cam ring 1426 and cam members 1427, 1428 to be positioned therein.

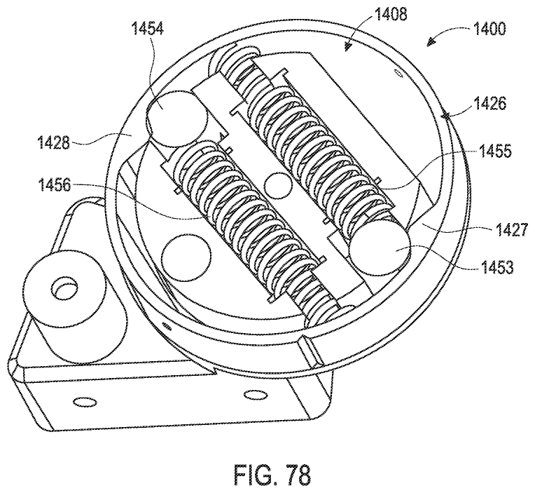

As illustrated in FIG. 78, which shows the interaction between the cover plate 1408 and the cam ring 1426 (without showing the rest of the second rotational component 1404), the springs 1455, 1456 bias the rollers 1453, 1454 to engage the inner perimeter of the cam ring 1426. When the hinge assembly 1400 is unlocked and the rear section of the ladder is rotated relative to the front section, the cam ring 1426 rotates along with the first and second rotational components 1402, 1404 against the rollers 1453, 1454. For the cam members 1427, 1428 to be rotated past the rollers 1453, 1454, the cam members 1427, 1428 force the rollers 1453, 1454 further into the channels 1459, 1460, compressing the springs 1455, 1456. When the cam members 1427, 1428 have passed the rollers 1453, 1454, the springs 1455, 1456 extend to return the rollers 1453, 1454 to their position against the inner perimeter of the cam ring 1426.

Similar to hinge assembly 400, when hinge assembly 1400 is locked into a locking hole 1443 of the first rotational component 1402 corresponding to the stepladder configuration or the lean-safe configuration, the rollers 1453, 1454 are each forced against the two cam members 1427, 1428 by their respective springs 1455, 1456 to take up slack in the hinge locking hole 1443, as illustrated best in FIG. 78. In the stepladder configuration the rollers 1453, 1454 are positioned pressed against one side or surface of the cam members 1427, 1428 while in the lean-safe configuration the rollers 1453, 1454 are positioned pressed against the other side or surface of the cam members 1427, 1428. The force of the rollers 1453, 1454 against the cam members 1427, 1428 slightly moves the first rotational component 1402 so that a side of the locking hole 1443 is held in tension against the locking bolt, which reduces the slack in the hinge.

It is noted that in some embodiments there may just be one roller, spring, and cam member. In other approaches there may be more than two each of the rollers, springs, and cam members. In addition, it is contemplated that the slack removing mechanism described for hinge assembly 1400 can also be included in a modified version of ladder 100 and hinge assembly 110 described above.

With reference to FIG. 72, there is shown a ladder 1500 that employs bumpers 1406 for reducing or eliminating slack in the folded or lean-safe configuration and in the extended straight configuration. Bumpers 1406 typically made of a compressible or soft material (e.g., rubber or a soft plastic) are attached to the front ladder section 1502 on the first and second rails 1502a, 1502b. A lower set of bumpers (e.g., 1506a and 1506b) are attached to rear-facing sides of the first and second front rails 1502as 1502b below a hinge assembly 1510 so that front-facing sides of the rear rails 1504a, 1504b contact and compress the bumpers 1506a, 1506b in the folded or lean-safe configuration. This squeeze creates a tension between the rails and thus between the stationary and rotational components of the hinge assembly 1510, removing slack therebetween. An upper set of bumpers (e.g., 1506c and 1506d) may also be attached to rear-facing sides of the first and second front rails 1502as 1502b above the hinge assembly 1510 so that front-facing sides of the rear rails 1504a, 1504b contact and compress the bumpers 1506c, 150db in the extended straight configuration. This squeeze creates a tension between the rails and thus between the stationary and rotational components of the hinge assembly 1510, removing slack therebetween. In some approaches, the positioning of the bumpers 1506 may be reversed, coupled to the rear ladder section 1504 instead of the front ladder section 1502.

The ladders, components, and/or accessories described herein may be formed of a variety of materials and using a variety of manufacturing techniques. Such materials may include, e.g., metals, plastics and other polymers, and/or composite materials. In addition, some portions of the ladder's components may be formed of one material and one or more other components or accessories may be formed of another similar, or entirely distinct material. In some configurations, the rails of the ladders may be formed of composite material such as fiberglass or fiberglass reinforced plastic (FRP) and may be manufactured via a pultrusion process. FRP materials may include various plastic resins, such as polyurethane or polyethylene, or may include various glass materials. It is contemplated that adjusting the FRP formula to use different material combinations may reduce material weight and/or cost. The rails may also be formed of a metal material such as aluminum or aluminum alloys and manufactured via an extrusion process. After extrusion or pultrusion, the ladder rails are typically cut to length. For box-shaped rails, a computerized numerical control (CNC) machine may machine or form one or more holes in the rails. For rails of other shapes, such as C-shaped or I-beam shaped rails, other tools such as a punch press may be leveraged to punch one or more holes into the rails.

The rungs of the ladders may be formed of composite materials such as fiberglass or carbon fiber. In some approaches, the rungs may also be formed of meatal materials such as magnesium, magnesium alloys, aluminum, or aluminum alloys. The rungs may be manufactured, for example, via an extrusion process and cut to length. The rungs may take a variety of shapes and may be, for example, rounded, D-shaped, or triangular. Further, the rungs may have a hollow or substantially hollow cross-section.

The rungs of a ladder may be attached to the rails in a variety of different manners. In one approach, the rungs and rails are forged together, such as by having the rungs being attached to the rails via a direct swage connection. In a direct swage connection, a rung is attached directly to the rails using a cold forming process, where a moving die shapes the rung around a hole that was pre-punched in the rail. Annealing operations may be used to soften the metal to prevent cracking. In other approaches, the rungs are attached to the rails via a rung-plate connection in addition to other attachment types. In a rung-plate connection, a rung is attached to a plate and the plate is attached to the rail via one or more rivets or other mechanical elements.

Other accessories and assemblies employed in the ladder, such as feet, locks, ropes, rope pullies, end caps, and/or knee braces may be made of materials such as rubber or plastics like polypropylene or any other suitable plastics. Plastic parts may be injection molded or insert molded. In some approaches, accessories and assemblies such as guide brackets, feet, knee braces, and/or locks, may be formed, extruded or stamped, from metal materials such as aluminum, aluminum alloys, or steel. Rubber feet may be riveted to a base of the ladder. Metal locks may be extruded and then cut to length. Rope pulleys may include extruded metal side portions and plastic round pulleys formed of injection molded plastic, with the side portions and pulley held together by a rivet. End caps may be riveted or snap fit to the ladder during assembly. Similarly, knee caps may be riveted to the ladder.

It will be understood that various changes in the details, materials, and arrangements of parts and components which have been described and illustrated above to explain the nature of the anchor device may be made by those skilled in the art within the principle and scope of the anchor device as expressed in the following claims. Furthermore, while various features have been described regarding a particular embodiment or a particular approach, the foregoing description and accompanying drawings is offered by way of illustration only and not as a limitation. Further, while embodiments have been shown and described, it will be apparent to those skilled in the art that modifications may be made to them without departing from the broader aspects of the technological contribution. The actual scope of the protection sought is defined in the following claims.

1. A lockable pivot arrangement for a ladder having a first ladder section and a second ladder section, each ladder section having first and second rails in parallel to one another and at least one rung connecting the first and second rails, the lockable pivot arrangement connecting the first and second ladder sections and enabling selective rotation of the second ladder section relative to the first ladder section, the lockable pivot arrangement including:
a first hinge, the first hinge comprising:
a first stationary plate fixed to the first rail of the first ladder section and having a first pin hole for receiving a first locking pin,
a first rotational plate fixed to the first rail of the second ladder section and rotatably coupled to the first stationary plate, the first rotational plate including a first plurality of locking holes for receiving the first locking pin to lock the second ladder section in a plurality of positions relative to the first ladder section,
a first cover plate fixed from rotation relative to the first stationary plate, the first cover plate including a first opening for receiving the first locking pin that is aligned with the first pin hole of the first stationary plate, wherein the first stationary plate is positioned between the first rotational plate and the first cover plate;
a second hinge, the second hinge comprising:
a second stationary plate fixed to the second rail of the first ladder section and having a second pin hole for receiving a second locking pin,
a second rotational plate fixed to the second rail of the second ladder section and rotatably coupled to the second stationary plate, the second rotational plate including a second plurality of locking holes for receiving the second locking pin to lock the second ladder section in a plurality of positions relative to the first ladder section,
a second cover plate fixed from rotation relative to the second stationary plate, the second cover plate including a second opening for receiving the second locking pin that is aligned with the second pin hole of the second stationary plate, wherein the second stationary plate is positioned between the second rotational plate and the second cover plate; and
a sliding lock mechanism positioned between the first hinge and the second hinge comprising:
the first locking pin and the second locking pin for engaging and disengaging the first plurality of locking holes and the second plurality of locking holes of the first and second rotational plates, respectively; and
a first sliding assembly including a first actuator coupled to the first locking pin and a second sliding assembly including a second actuator coupled to the second locking pin, the first sliding assembly and the second sliding assembly being biased away from each other;
wherein an unlocked state of the first and second hinges is provided when the first and second actuators are moved towards each other and against the bias so that the first and second locking pins exit one of the first plurality of locking holes and one of the second plurality of locking holes of the first and second rotational plates, respectively, to allow rotation of the second ladder section relative to the first ladder section.

2. The lockable pivot arrangement of claim 1, wherein the first rotational plate comprises an outermost portion of the first hinge.

3. The lockable pivot arrangement of claim 2, wherein the first plurality of locking holes of the first rotational plate extend entirely through the first rotational plate so that the first plurality of locking holes, and the first locking pin when inserted in one of the first plurality locking holes, are externally visible.

4. The lockable pivot arrangement of claim 1, wherein the first cover plate includes a plurality of projections extending axially from the first cover plate that engage the first stationary plate to fix the first cover plate from rotation relative to the first stationary plate.

5. The lockable pivot arrangement of claim 4, wherein the plurality of projections are spaced about a perimeter region of the first cover plate.

6. The lockable pivot arrangement of claim 4, wherein the plurality of projections are received in corresponding cut-outs spaced about the first stationary plate to fix the first cover plate from rotation relative to the first stationary plate.

7. The lockable pivot arrangement of claim 6, wherein the plurality of projections are sized to extend farther than the cut-outs when they are received within the cut-outs so that the plurality of projections space the first rotational plate from the first stationary plate.

8. The lockable pivot arrangement of claim 1, wherein a first locking hole of the first plurality of locking holes includes a bushing inserted therein that inhibits deformation of the first locking hole over time.

9. The lockable pivot arrangement of claim 8, wherein the bushing includes an annular recess that captivates an annular rib of the first locking hole.

10. The lockable pivot arrangement of claim 1, wherein in the unlocked state the first locking pin does not disengage the first pin hole of the first stationary plate and does not disengage the first opening of the first cover plate.

11. The lockable pivot arrangement of claim 1, wherein an elongate housing is coupled to the first cover plate and the second cover plate and houses the sliding lock assembly.

12. The lockable pivot arrangement of claim 11, wherein the first cover plate includes a channel projecting about the first opening on a side of the first cover plate facing the sliding lock mechanism; the channel supporting the elongate housing.

13. (canceled)

14. The lockable pivot arrangement of claim 1, wherein the sliding lock mechanism includes a fixed plate having a bearing surface projecting upwardly from the fixed plate and supporting the first locking pin, and wherein moving the first actuator towards the second actuator causes the first sliding assembly to compress a spring against the bearing surface.

15. The lockable pivot arrangement of claim 14, the first sliding assembly further including a first upwardly projecting flange positioned at an end of the first sliding assembly and the spring extends between the first flange and the bearing surface; wherein moving the first actuator towards the second actuator causes the first flange to move and compress the spring against the bearing surface.

16-20. (canceled)

21. A ladder, comprising
a first ladder section and a second ladder section, each ladder section having first and second rails in parallel to one another and at least one rung connecting the first and second rails, and
a hinge connecting the first and second ladder sections and enabling selective rotation of the second ladder section relative to the first ladder section, the hinge including:
a first plate fixed to the first rail of the first ladder section; and
a second plate fixed to the first rail of the second ladder section, the first plate and the second plate being rotatably coupled;
wherein the first plate and the second plate each include at least one hole for receiving a locking pin of a locking assembly to lock the first ladder section and the second ladder section in position relative to one another, and
wherein the first plate includes a bushing extending through a first hole of the at least one hole to inhibit deformation of the first hole during use of the ladder.

22. The ladder of claim 21, wherein the first plate is an outermost plate of the hinge.

23. The ladder of claim 21, wherein the hinge comprises a third plate fixed to an elongated housing containing the locking assembly for the hinge, and the second plate is positioned between the first plate and the third plate.

24. The ladder of claim 21, wherein the bushing comprises an annular body defining an opening for receiving the locking pin.

25. The ladder of claim 24, wherein the bushing includes a flange extending radially from one end of the annular body.

26. The ladder of claim 25, wherein the flange is spaced from the second plate.
